(19) United States
(12) Patent Application Publication
(10) Pub. No.: US 2011/0262018 A1
(43) Pub. Date: Oct. 27, 2011

(54) Automatic Cardiac Functional Assessment Using Ultrasonic Cardiac Images

(75) Inventors: Anurag Kumar, Bangalore (IN); Jaideep Hari Rao, Bangalore (IN); Prashanta Kumar, Udupi (IN); Sampath Krishnan Yerragudi Venugopalacharyulu, Bangalore (IN); Sudha Kanth, Bangalore (IN); Rakshan Kumar, Udupi (IN)

(73) Assignee: MindTree Limited

(21) Appl. No.: 12/797,633

(22) Filed: Jun. 10, 2010

(30) Foreign Application Priority Data
Apr. 27, 2010 (IN) 1160/CHE/2010

(51) Int. Cl. G06K 9/00

(52) U.S. Cl. 382/131

(57) ABSTRACT

A computer implemented method and system for fully-automatic cardiac functional assessment are provided. Automatic segmentation of a series of ultrasonic cardiac images is performed for delineating an endocardium boundary and an epicardium boundary, in each of the ultrasonic cardiac images using a segmentation algorithm. Multiple acoustic markers are identified on the endocardium boundary on the ultrasonic cardiac images. The acoustic markers are tracked across the ultrasonic cardiac images over multiple cardiac cycles using a tracking algorithm. Multiple cardiac parameters are calculated using the tracked acoustic markers on drift compensated ultrasonic cardiac images. The computer implemented method and system for cardiac functional assessment is fully-automatic without requiring user intervention or inputs.

### CROSS REFERENCE TO RELATED APPLICATIONS

This application claims the benefit of non-provisional patent application number 1160/CHE/2010 titled “Automatic Cardiac Functional Assessment Using Ultrasonic Cardiac Images”, filed on Apr. 27, 2010 in the Indian Patent Office.

The specification of the above referenced patent application is incorporated herein by reference in its entirety.

### BACKGROUND

Cardiac functional assessment refers to the measurement and analysis of cardiac parameters, where specific cardiac parameters such as left ventricular volume, ejection fraction, tissue strain, etc. are assessed and used by cardiologists and echocardiographers to diagnose cardiac diseases. Much of the present day cardiac functional assessment is manual and subjective, and has a high dependency on the interpretation of echocardiograms by a medical practitioner, which can vary from practitioner to practitioner.

Cardiac functional assessment referred herein as cardiac computer-aided detection (CAD), using non-Doppler ultrasound data, that is, using two dimensional (2D) B-mode echocardiogram data, is a new and emerging technology that allows non-subjective and non-invasive cardiac functional assessment using digital signal and image processing algorithms. Given the significance and importance of cardiac diseases, there is a high demand for cardiac functional assessment systems, which can be operated by cardiologists and echocardiographers with minimal experience. Existing cardiac CAD systems are manual or semi-automatic. Manual cardiac CADs require an experienced cardiologist or echocardiographer to operate them. An experienced cardiologist or echocardiographer has to perform a series of manual input operations in a particular sequence and provide inputs to the cardiac CAD to quantify the cardiac parameters. Typically, these manual input operations take several minutes, for example, about 15 minutes to 30 minutes.

In existing cardiac CAD systems, tissue tracking algorithms are employed to estimate the cardiac parameters. These algorithms are sensitive to image statistics and the manner in which the echocardiogram is recorded during a cardiac ultrasound scan. For example, any tilt or “jitter” in the position of the ultrasound probe, the breathing-rhythm of the patient, the movement of the patient, reflections from non-cardiac artifacts and out-of-plane motion, called dropouts, impact the signal-to-noise (SNR) and tracking quality. This in turn impacts the overall accuracy of the quantified cardiac parameters. Furthermore, most existing cardiac CADs are dependent on specific advanced ultrasound scanners, that is, the cardiac CADs can only operate with echocardiograms captured by specific ultrasound scanners, which are usually expensive.

Hence, there is a long felt but unresolved need for a fully automated, online and/or offline, vendor-independent computer implemented method and system for quantitatively assessing cardiac parameters using echocardiograms, herein referred to as ultrasonic cardiac images.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The computer implemented method and system disclosed herein addresses the above stated need for a fully automatic, online and/or offline, vendor-independent computer implemented method and system for cardiac functional assessment of a left ventricle using a series of ultrasonic cardiac images. The fully-automatic computer implemented method and system disclosed herein eliminates the need for an experienced echocardiographer to perform meticulous input operations, and consequently improves the overall cardiac functional assessment by several orders and in a reduced amount of time, for example, two to three minutes. The computer implemented method and system disclosed herein employs a segmentation algorithm and a tissue tracking algorithm for automatically segmenting the left ventricular endocardium and epicardium boundaries and tracking the ventricular tissue in a given set of ultrasonic cardiac images. The computer implemented method and system disclosed herein provides automatically calculated inputs required by the segmentation algorithm for delineating the endocardium boundary. The tracking algorithm disclosed herein is based on a speckle tracking algorithm and adapts a few tracking parameters with respect to parameters of the ultrasonic cardiac images. The tracking algorithm further employs “synthetic phase” and utilizes drift compensation or “lock-on” algorithms for tracking acoustic markers.

By way of the above mentioned algorithms, the vendor-independent computer implemented method and system disclosed herein allows fully-automatic cardiac functional assessment by quantification of cardiac parameters using echocardiograms captured by ultrasound scanners from any vendor. Furthermore, it provides both offline and online cardiac functional assessment modes and operates as a standalone portable and flexible system on a general computing device.

A series of ultrasonic cardiac images from, for example, echocardiograms are obtained from an echocardiogram database, for example, in an offline mode. Automatic segmentation of each of the ultrasonic cardiac images is performed for delineating the inner myocardial boundary or the endocardium boundary in each of the ultrasonic cardiac images by using a segmentation algorithm, for example, a region based active contour segmentation algorithm. The active contour segmentation algorithm allows fully-automatic segmentation of the ventricular boundary without user intervention and inputs. Multiple ventricular tissue segments, defined using acoustic markers, are automatically identified on the delineated endocardium boundary on a first ultrasonic cardiac image. These identified acoustic markers are then tracked across the rest of the ultrasonic cardiac images over one or more cardiac cycles using a tracking algorithm based on speckle tracking echocardiography. The tracking algorithm dynamically adapts the size of the acoustic markers with respect to the statistics of the ultrasonic cardiac images. The tracking algorithm utilizes a synthetic phase algorithm for robust tracking of the acoustic markers. The phenomenon of “drift” caused due to the movement artifacts in the ultrasonic cardiac images, which in turn reduces the accuracy of the assessed or quantified cardiac parameters, is compensated by using a compensation or lock-on algorithm. The computer implemented method and system disclosed herein maximize the robustness of the segmentation and tracking algorithms, which in turn maximize the overall accuracy and quality of the quantified cardiac parameters.

The cardiac parameters are then calculated using the tracked acoustic markers on the ultrasonic cardiac images. The cardiac parameters calculated using the tracked acoustic markers comprise, for example, tissue displacement, and one or more derived cardiac parameters. The derived cardiac parameters comprise, for example, tissue velocity, tissue strain, tissue strain rate, ventricular volume, and ventricular ejection fraction. The quantified cardiac parameters are displayed in a parametric format and/or a graphical format on a graphical user interface on a computing device.

One or more periodic stages of each of the cardiac cycles, for example, expressed as systolic and diastolic frames are determined using the segmented ultrasonic cardiac images. An area defined within the endocardium boundary is calculated in each of the ultrasonic cardiac images. The end-systole image frames among the segmented ultrasonic cardiac images are isolated, wherein each of the end-systole image frames defines a minimum area within the endocardium boundary. The end-diastole image frames among the ultrasonic cardiac images are isolated, wherein each of the end-diastole image frames defines a maximum area within the endocardium boundary.

The computer implemented method and system disclosed herein calculates the total cardiac cycles and an instantaneous heart beat rate and/or an average heart beat rate by determining frequency of the cardiac cycles based on recurrence of one or more of the end-systole image frame pairs and the end-diastole image frame pairs.

The segmentation algorithm, for example, a region-based active contour algorithm is configured to automatically delineate the inner myocardial boundary or the endocardium boundary using localized image statistics. The computer implemented method and system disclosed herein automatically generates an initial contour that constitutes an input to the region-based active contour algorithm. The initial contour is generated by calculating multiple cross-sectional intensity profiles of the left ventricle on the ultrasonic cardiac images. The cross-sectional intensity profiles are also used to automatically calculate a localization factor that constitutes another input to the region-based active contour algorithm. These allow a full-automatic segmentation of the endocardium.

The computer implemented method and system disclosed herein further identifies an apex of a left ventricle by determining one or more acoustic markers with the least displacement across the ultrasonic cardiac images. The basal points of the left ventricle are then identified by determining one or more acoustic markers with the largest or most displacement across the ultrasonic cardiac images and by their predefined geometric relationship with the apex of the left ventricle. A long-axis and a short-axis of the left ventricle are determined. The long-axis of the left ventricle is determined by joining the apex of the left ventricle and a mid point of a line segment that joins the basal points of the left ventricle. The short-axis is determined by a predetermined geometric interpolation between the apex of the left ventricle and basal points of the left ventricle.

The computer implemented method and system disclosed herein segments the outer myocardial boundary or the epicardium boundary using the segmented endocardium boundary. The acoustic markers of the endocardium boundary are projected outwardly in a direction perpendicular to a tangent line at each of the acoustic markers. The intensity level along each of the projected acoustic markers is measured by traversing the projections to locate epicardium boundary points. These epicardium boundary points define a specific range of intensity gradients on the projections. The determined epicardium boundary points are joined for segmenting or delineating the epicardium boundary.

The computer implemented method and system disclosed herein employs an adaptive speckle tracking algorithm for tracking acoustic markers across the ultrasonic cardiac images. Acoustic marker search blocks are employed for searching the acoustic markers on each of the ultrasonic cardiac images. The acoustic markers are tracked by correlating the acoustic markers in a current ultrasonic cardiac image with sub-sections of the acoustic marker search blocks in the subsequent ultrasonic cardiac image. The dimensions of the acoustic markers are dynamically adapted based on parameters of image statistics, for example, image intensity. The dimensions of the acoustic marker search blocks are dynamically adapted based on the frame rate of the ultrasonic cardiac images.

The computer implemented method and system disclosed herein determines a synthetic phase component for robustly tracking the acoustic markers. A resultant displacement of each of a set of adjacent acoustic markers is calculated in terms of individual phase components. The synthetic phase component is determined for the set of adjacent acoustic markers based on an orientation of a majority of the individual phase components.

The computer implemented method and system disclosed herein compensates movement artifacts in the ultrasonic cardiac images for improving the tracking of the acoustic markers. The compensation is performed by shifting the location of the acoustic markers on each subsequent end-systole image frame towards one or more reference acoustic markers located on the first end-systole image frame. In another embodiment, the movement artifacts in the ultrasonic cardiac images are compensated by shifting the location of the acoustic markers on each subsequent end-diastole image frame towards one or more reference acoustic markers located on the first end-diastole image frame.

The computer implemented method and system disclosed herein estimates and corrects a tilt in each of the ultrasonic cardiac images. The ultrasonic cardiac images are divided into at least four quadrants with reference to a vertical axis and a horizontal axis of a cardiac ultrasound. A tilt angle between the estimated long-axis of the left ventricle and the vertical axis of the cardiac ultrasound is calculated. The tilt angle is corrected by transforming the coordinates of the ventricular axis of the left ventricle to align with coordinates of the cardiac ultrasound axis.

The foregoing summary and the following detailed description refers to the cardiac functional analysis of the left ventricle; however the scope of the computer implemented method and system disclosed herein is not limited to functional analysis of the left ventricle but may be extended to include the fully automatic cardiac functional analysis of other heart chambers, for example, right ventricle, left atrium or the right atrium.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a computer implemented method for performing automatic cardiac functional assessment using a series of ultrasonic cardiac images.

FIG. 2 exemplarily illustrates a cross-sectional view of a left ventricle.

FIG. 3 exemplarily illustrates a technique for localizing a region-based active contour algorithm.

FIG. 4A exemplarily illustrates intensity profiles for two cross-sections of the left ventricle.

FIG. 4B exemplarily illustrates a graphical format of displaying intensity vectors of the intensity profiles.

FIG. 4C exemplarily illustrates tracing of four intensity profiles.

FIG. 5A exemplarily illustrates a computer implemented method for identifying an apex and basal points on the left ventricle and determining a long-axis and a short-axis of the left ventricle.

FIG. 5B exemplarily illustrates endocardium displacement at successive time periods and minimum and maximum displacements of the apex and basal points respectively.

FIG. 6A exemplarily illustrates a computer implemented method for delineating an epicardium boundary.

FIG. 6B exemplarily illustrates projections of the acoustic markers on the endocardium boundary onto the epicardium boundary.

FIG. 7 exemplarily illustrates a computer implemented method for determining one or more periodic stages of the cardiac cycles.

FIG. 8A exemplarily illustrates tracking of an acoustic marker between successive ultrasonic cardiac images.

FIG. 8B exemplarily illustrates an adaptive method of tracking acoustic markers across the ultrasonic cardiac images.

FIG. 8C exemplarily illustrates a pseudocode for an adaptive speckle tracking algorithm.

FIG. 8D exemplarily graphically illustrates implementation of the adaptive speckle tracking algorithm.

FIG. 9 exemplarily illustrates a synthetic phase algorithm.

FIG. 10A exemplarily illustrates a strain graph showing drift compensation in the ultrasonic cardiac images.

FIG. 10B exemplarily illustrates a pseudocode for a drift compensation algorithm.

FIG. 11A exemplarily illustrates a ventricular axis with reference to an echocardiogram axis.

FIG. 11B exemplarily illustrates a computer implemented method for estimating and correcting tilt in the ultrasonic cardiac images.

FIG. 12 exemplarily illustrates a computer implemented system for performing automatic cardiac functional assessment using a series of ultrasonic cardiac images.

FIG. 13 exemplarily illustrates the architecture of a computer system used for automatic cardiac functional assessment.

FIG. 14A exemplarily illustrates a graphical user interface for displaying the calculated cardiac parameters in a parametric format.

FIG. 14B exemplarily illustrates a graphical user interface for displaying cardiac parameters, depicting the tissue segmental strain parameters in a graphical format.

FIGS. 15A-15B exemplarily illustrate screenshots of a graphical user interface for displaying cardiac parameters.

FIGS. 16A-16C exemplarily illustrate screenshots of a left ventricle with varying shapes captured using different ultrasound scanners and segmented using the segmentation algorithm.

### DETAILED DESCRIPTION OF THE INVENTION

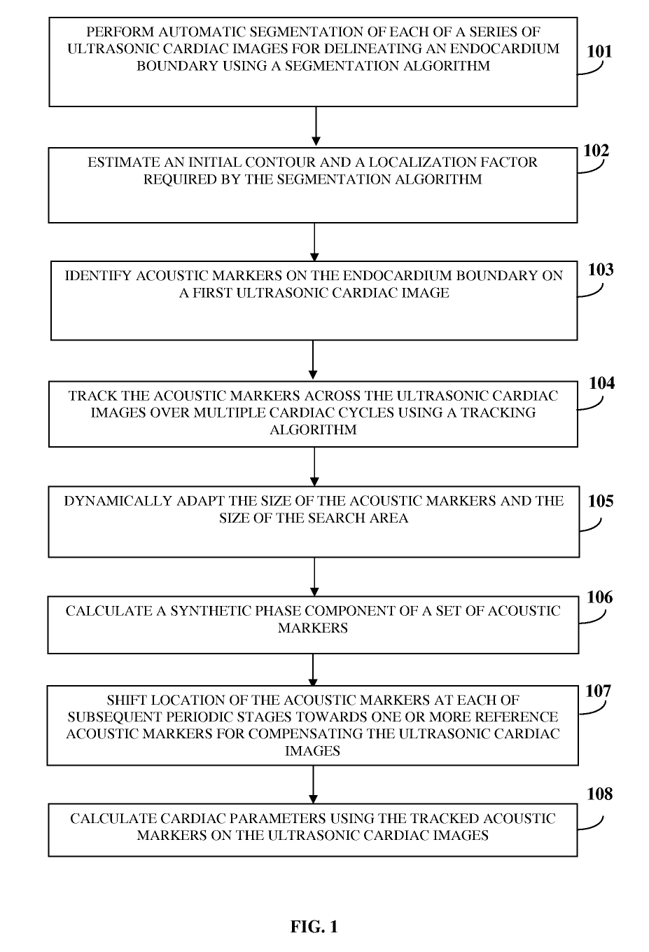

FIG. 1 illustrates a computer implemented method for performing automatic cardiac functional assessment using a series of ultrasonic cardiac images. A series of ultrasonic cardiac images, for example, echocardiograms are obtained from an echocardiogram database, for example, in an offline mode. Automatic segmentation of each of the ultrasonic cardiac images is performed 101 for delineating an endocardium boundary in each of the ultrasonic cardiac images using a segmentation algorithm. The segmentation algorithm is, for example, based on a region-based active contour algorithm. The segmentation algorithm is configured to automatically delineate the endocardium boundary using localized image statistics. The computer implemented method and system disclosed herein automatically estimates 102 an initial contour and a localization factor that constitute inputs to the segmentation algorithm for delineating the endocardium boundary. One or more periodic stages of each of the cardiac cycles, for example, expressed as systolic and diastolic image frames, are determined using the segmented ultrasonic cardiac images, using which the total cardiac cycles and an instantaneous and/or an average heart beat rate are calculated.

Multiple acoustic markers are automatically identified 103 on the endocardium boundary on a first ultrasonic cardiac image. The identified acoustic markers are tracked 104 across the ultrasonic cardiac images over one or more cardiac cycles using a tracking algorithm. The tracking algorithm is based on a speckle tracking echocardiography algorithm that relies on random speckles appearing on the ultrasonic cardiac images due to scattering and reflection of ultrasound beams in a myocardial tissue. The tracking algorithm dynamically adapts 105 dimensions, for example, the size of the acoustic markers with reference to the image statistics and dynamically adapts the size of the search area, where the acoustic markers are searched in each subsequent image frame, with respect to the image frame rate. The tracking algorithm further calculates 106 a synthetic phase component of a set of adjacent acoustic markers for robust tracking of the acoustic markers. The tracking algorithm compensates for the movement artifacts, for example, drift in the ultrasonic cardiac images by using a compensation or lock-on algorithm. The location of the acoustic markers on the ultrasonic cardiac images at each subsequent periodic stage, for example, on each subsequent diastolic image frame is measured, and the measured location is shifted 107 or “locked-on” towards one or more reference acoustic markers that were located during the first periodic stage, for example, on the first diastolic image frame. Cardiac parameters are calculated 108 using the tracked acoustic markers on the ultrasonic cardiac images. The cardiac parameters calculated using the tracked acoustic markers comprise, for example, tissue displacement, and one or more derived cardiac parameters. The derived cardiac parameters comprise, for example, tissue velocity, tissue strain, tissue strain rate, ventricular volume, and ventricular ejection fraction.

In the computer implemented method disclosed herein, the segmentation algorithm is a region based active contour algorithm. Active contours (AC) or deformable models are a class of algorithms widely used for image segmentation. The basic concept in AC based segmentation is to evolve an initial contour under the influence of internal and external energies till an equilibrium is reached. With this formulation, active contours (AC) are categorized as parametric or explicit and non-parametric or implicit, in terms of the representation of the contour. Further, active contours are categorized as edge-based or region-based, where the edge-base active contours define stopping criteria based on a specific gradient-threshold in the image, while region-based active contours use specific image statistics of the image to define the stopping criteria. The computer implemented method disclosed herein uses a region-based and non-parametric AC segmentation algorithm.

In the region-based AC algorithms, the energy functional is based on global image-statistics, for example, average intensity, color or texture. This makes region-based AC less prone to leakage and local-minima effects and enables them to segment images whose boundaries have varying gradient levels.

Non-parametric AC embeds the initial contour in a high dimensional scalar function, defined over the entire cardiac image domain. This is commonly known as a level-set method. The contour is represented implicitly as the zero-th. (0^{th}) level set of the high dimensional scalar function. Over the rest of the image space, the level-set function is defined as the signed distance function from the zero-th level set. Specifically, given a closed contour C, the function is zero if a pixel lies on the contour, otherwise the function is the signed minimum distance from the pixel to the contour. By convention, the signed distance is regarded as negative for pixels outside contour C and positive for pixels inside contour C. The level-set function φ of the closed contour C is defined as:

φ(x, y)=±d((x,y), C)

where ±d((x, y),C) is the distance from point (x, y) to the contour C and the ± sign is chosen if the point (x, y) is inside or outside of contour C.

The contour is now represented implicitly as the zero-th level set of this scalar function:

C−{(x, y)/φ(x,y)−0}

The function φ which varies with space and time is then evolved using a partial differential equation (PDE) containing terms that are either hyperbolic or parabolic in nature. The evolution of φ is in a direction normal to itself with a known speed F.

The computer implemented method disclosed herein uses a combination of region-based and level set AC algorithms. The computer implemented method disclosed herein improves upon the existing region-based AC algorithm, for example, the Chan-Vese algorithm in order to adapt the algorithm for ultrasonic cardiac image segmentation. The Chan-Vese algorithm has an energy functional that is independent of an image gradient. The Chan-Vese algorithm assumes that an image μₒ is formed by two regions of approximately constant intensities, μᵥⁱ and μᵤ^{o} and that the object to be segmented is represented by a region with the value μₒⁱ. If the boundary of this region is approximated by a contour Cₒ, then μₒ≈μᵤⁱ inside the contour and μₒ≈μᵤ^{o} outside this contour. Consider the energy functional:

$$\begin{matrix}E ( C ) = F 1 ( C ) + F 2 ( C ) \\ = {\int }_{inside ( C )} {\vert {μ}_{o} - {c}_{1} \vert}^{2} d x + {\int }_{outside ( C )} {\vert {μ}_{o} - {c}_{1} \vert}^{2} d x\end{matrix}$$

where C is a contour and c₁ and c₂ are the constant intensities inside and outside the contour respectively. As such, this functional would be minimized when C=C₀; that is when the contour lies on the boundary of the object that is to be segmented.

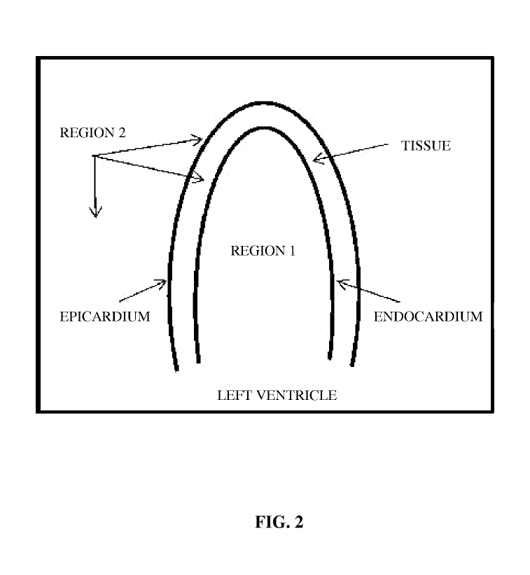

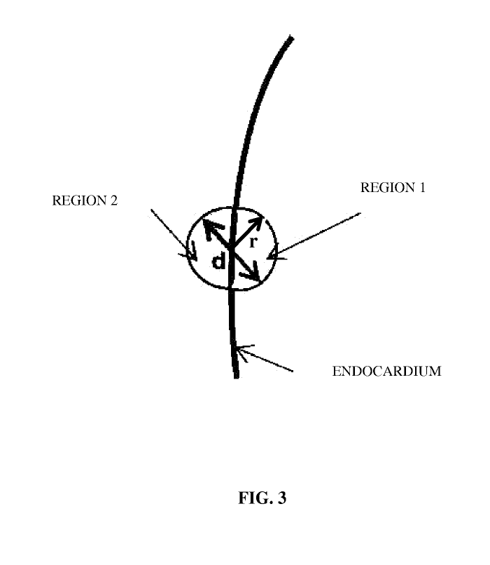

The Chan-Vese algorithm aims to minimize this energy functional E(C) by formulating it as a PDE. The Chan-Vere model is based on the global image statistics, that is, it assumes that two regions have constant intensities. FIG. 2 exemplarily illustrates a cross-sectional view of a left ventricle. As exemplarily illustrated in FIG. 2, region 1 is an area enclosed within the endocardium, that is, the blood pool and region 2 is an area outside the endocardium comprising the tissue, epicardium, and the area beyond the epicardium. Region 1 and region 2 can have non-constant intensities, especially region 2 which is composed of multiple entities. In addition, there are scenarios when the intensities of both these regions can overlap or be almost the same. Such conditions can lead to erroneous endocardium segmentation using the Chan-Vese algorithm. The computer implemented method disclosed herein addresses this problem by introducing a local image statistic term in the energy functional. The assumption is that the image statistics are constant and distinct in areas adjacent to the boundary that needs to be segmented. FIG. 3 exemplarily illustrates a technique for localizing the region-based AC algorithm. As exemplarily illustrated in FIG. 3, region 1 and region 2 are localized to the regions enclosed within the circle with diameter “d” or with radius “r” 30 . at the endocardium boundary. In effect, the regions of the Chan-Vese model are scaled down, or are localized around the endocardium boundary. This transforms the global region-based AC algorithm to a localized region-based AC algorithm. Though the localized region-based AC algorithm is comparatively more robust than the global region-based AC algorithm, the localized region-based AC algorithm is very sensitive to the amount of localization, that is, the factor “r”. The localized region-based AC algorithm is also sensitive to the location where the initial contour is placed. Both these factors are extremely critical to achieve correct segmentation. The computer implemented method disclosed herein demonstrates a localized region-based AC algorithm for endocardium segmentation, where the localization factor “r” and the initial position of the contour are estimated automatically. This makes the task of endocardium segmentation fully automatic.

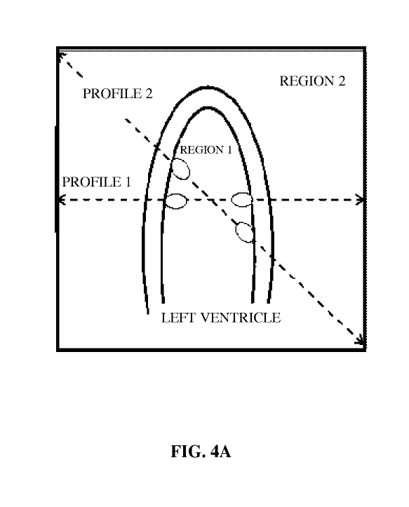

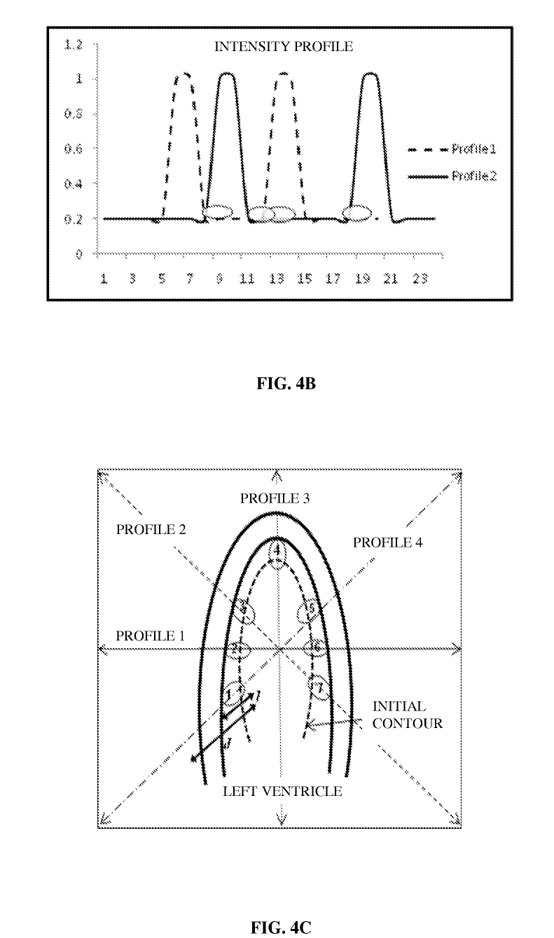

FIG. 4A exemplarily illustrates intensity profiles for two cross-sections of the left ventricle. An observation in a typical echocardiogram is that the left ventricle is parabolic shaped and is the dominant artifact in the echocardiogram. A cross-sectional intensity profile of the left ventricle has almost the same pattern in any echocardiogram. As observed, both the intensity profiles, profile 1 and profile 2, follow a similar pattern, where the intensity is high, for example, about 1, on the tissue segments and low, for example, about 0 elsewhere. The intensity profiles can be formulated as intensity-vectors which have a characteristic pattern, as observed by the intensity-vectors V1 and V2 as follows:

V1=[0,0,0,0,0,0,0,0,0,0,0,1,1,1,1,0,0,0,0,0,0,0,0,0,0,0,0,0,0,0,0,0,0,0,0,0,1,1,1,1,0,0,0,0,0,0,0, 0,0]

V2=[0,0,0,0,0,0,0,0,0,0,0,1,1,1,1,0,0,0,0,0,0,0,0,0,0,0,0,0,0,0,0,0,0,0,0,0,1,1,1,1,0,0,0,0,0,0,0, 0,0]

V1 and V2 correspond to profile 1 and profile 2 respectively as exemplarily illustrated in FIG. 4A and FIG. 4B. FIG. 4B illustrates a corresponding graphical format of displaying the intensity vectors of the intensity profiles, profile 1 and profile 2.

In the vectors V1 and V2, the zero (˜0) elements correspond to low intensity non-tissue areas and the ones (˜1) correspond to high intensity tissue areas. Also, each element corresponds to the spatial location of the corresponding pixel that the element represents. Hence, the vector can be formulated as an N×3 matrix, whose first column represents the intensity level i and the second and third columns correspond to the x and y coordinates of the pixel. Each row of this matrix corresponds to a single pixel. An example matrix with N=3 for vector V1 is as follows:

$$V 1 = ( \begin{matrix}i 1 & x 1 & y 1 \\ i 2 & x 2 & y 2 \\ i 3 & x 3 & y 3\end{matrix} )$$

The pattern of any intensity-vector, for example, V1 and V2 is the same. Traversing the vectors from left to right, the spatial location adjacent to the endocardium on the inside, that is, on region 1, corresponds to the starting and ending positions of a second subset of zeros. This is highlighted in bold and italicized in vectors V1 and V2 and by the oval-shaped circles in FIGS. 4A-4B. This observation is utilized to create an array of circles or points adjacent to the endocardium in region 2 by tracing several intensity profiles. FIG. 4C exemplarily illustrates tracing of four intensity profiles and the resulting 7 adjacent circles or points near the endocardium. These adjacent points (1-7) allow estimation of the scaling factor or localization factor r that is required for the localized region-based AC algorithm. Typically, these points are around 8-10 pixels in length, as observed in the vectors V1 and V2. As such, the scaling factor r=l, where l is the length of the adjacent points estimated from the intensity-vector, for example, V1 and V2.

The position of the initial contour is estimated by connecting all these adjacent points (1-7), as illustrated in FIG. 4C, where the dotted line connects point 1 to 7. The estimated localization factor r and the initial contour are used as inputs to the localized region-based AC algorithm. This ensures that an accurate automatic segmentation of the endocardium is achieved for any echocardiogram.

The overall localized region based AC algorithm is formulated in the level-set paradigm herein as follows. The Chan-Vese energy functional is given by:

$$\begin{matrix}E ( C ) = F 1 ( C ) + F 2 ( C ) \\ = {\int }_{inside ( C )} {\vert {μ}_{o} - {c}_{1} \vert}^{2} d x + {\int }_{outside ( C )} {\vert {μ}_{o} - {c}_{1} \vert}^{2} d x\end{matrix}$$

The level-set formulation of this functional defined over the image domain Ω is:

E(Ø, c₁, c₂)=∫^{Ω}|μₒ−c₁|²∇H(Ø)dx+∫_{Ω}|μₒ−c₂|²(1−∇H(Ø))dx

where H(Ø) is the Heaviside function:

$$H ( ∅ ( x ) ) = \{ \begin{matrix}1 when ∅ ( x ) & < - ɛ \\ 0 when ∅ ( x ) & > ɛ \\ \frac{1}{2} \{ 1 + \frac{∅}{ɛ} + \frac{1}{π} sin ( \frac{π ( ∅ ( x )}{ɛ} ) \} & otherwise\end{matrix}$$

The level-set representation of c₁ and c₂ is:

$${c}_{1} ( ∅ ) = \frac{{\int }_{Ω} {μ}_{o} H ( ∅ ) d x}{{\int }_{Ω} H ( ∅ ) d x}$$

$${c}_{2} ( ∅ ) = \frac{{\int }_{Ω} {μ}_{o} ( 1 H ( ∅ ) ) d x}{{\int }_{Ω} ( 1 H ( ∅ ) ) d x}$$

The localization of this energy functional is performed by defining a function:

$$B ( x , y ) = \{ \begin{matrix}1 when \vert x - y \vert & < {r}_{c} \\ 0 & otherwise\end{matrix}$$

where x is a point on the boundary and r_{c} is the localization factor, which essentially is the radius around x that defines the local area, as illustrated in FIG. 3 and y is a variable. This function will be 1 when the point y is within the ball of radius r_{c}.

This function is used to localize the Chan-Vese energy functional, in which terms c₁ and c₂ are localized, and are given by:

$${c}_{1 l} ( ∅ ) = \frac{{\int }_{Ω} B ( x , y ) {μ}_{o} H ( ∅ ) d x}{{\int }_{Ω} B ( x , y ) H ( ∅ ) d x}$$

$${c}_{2 l} ( ∅ ) = \frac{{\int }_{Ω} B ( x , y ) {μ}_{o} ( 1 - H ( ∅ ) ) d x}{{\int }_{Ω} B ( x , y ) ( 1 - H ( ∅ ) ) d x}$$

The localized version of the energy functional is then represented as:

E(Ø, c₁ₗ, c₂ₗ)=∫_{Ω}|μₒ−c₁ₗ(Ø)|²∇H(Ø)dx+∫_{Ω}|μₒ−c₂ₗ(Ø)|²(1−∇H(Ø))dx

The PDE of this functional is given by:

$$\frac{\partial ∅ ( x )}{\partial t} = δ∅ ( x ) {\int }_{Ω y} B ( x , y ) δ∅ ( y ) ( {( {μ}_{o} - {c}_{1 l} )}^{2} - {( {μ}_{o} - {c}_{2 l} )}^{2} ) d y + λ∅ ( x ) div ( \frac{∇ ∅ ( x )}{\vert ∇ ∅ ( x ) \vert} ) ‖ ∇ ∅ ( x ) ‖$$

The second term in this PDE is added in the functional as a regularization term, to keep the contour smooth.

Here, δ Ø(x) is the derivative of H(Ø) and is defined as:

$$δ ( ∅ ( x ) ) - \{ \begin{matrix}1 when ∅ ( x ) & = 0 \\ 0 when ∅ ( x ) & < ɛ \\ \frac{1}{2 ɛ} \{ 1 + cos ( \frac{π ( ∅ ( x )}{ɛ} ) \} & otherwise\end{matrix}$$

This PDE is then evolved using the estimated value of the scaling factor r and the estimated position of the initial contour, till the equilibrium condition is reached.

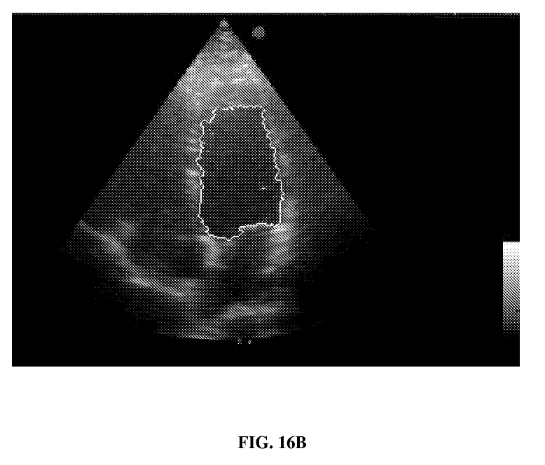

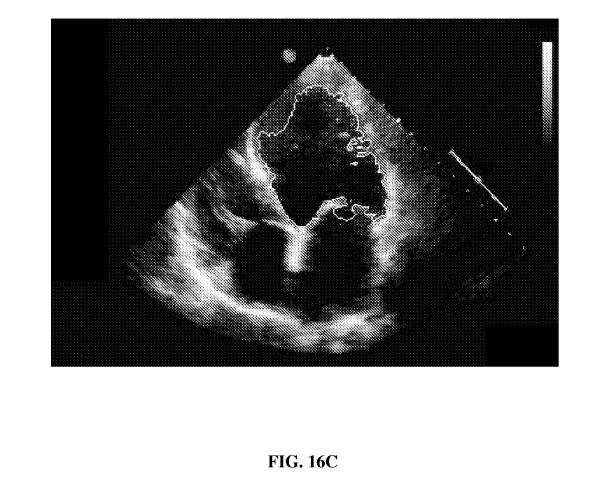

The above procedure demonstrates the fully-automatic segmentation of the endocardium using the localized region based and level-set AC algorithm. FIGS. 16A-16C exemplarily illustrate a graphical user interface displaying the results of the segmentation algorithm disclosed herein. As illustrated in FIGS. 16A-16C, the segmentation algorithm successfully segments the endocardium of left ventricles having varying shapes and sizes. Also, the echocardiograms are captured using different ultrasound scanners and hence have different signal-to-noise (SNR) levels.

In an embodiment, the energy functional of the localized region based AC algorithm can be constrained by a shape-prior term. This means that the shape of the segmented contour can be constrained to take the shape that resembles a ventricle. This shape would be parabolic as the shape of the ventricle resembles a parabola. In another embodiment, AC algorithms whose energy functional are designed to be suitable for endocardium segmentation can be used in lieu of the localized region based AC algorithm.

The acoustic markers are automatically identified on the segmented endocardium. As exemplarily illustrated in FIG. 4C, the cross sectional intensity profiles are estimated on the echocardiogram. The acoustic markers are identified using these multiple cross-sectional intensity profiles of the left ventricle on the ultrasonic cardiac images. With reference to FIG. 4C, the acoustic markers correspond to the points 1-7 that define the ventricular tissue segments in the parametric image. Since the acoustic markers are located in a region adjacent to the endocardium boundary, the acoustic markers are pushed slightly outwards, such that they lie over the ventricular tissue. These acoustic markers are then tracked using a tracking engine and the results of this tracking are used for calculating the cardiac parameters.

The segmented endocardium contour is available as a vector. The elements of this contour vector are unevenly spaced. The first step in tracking is to evenly distribute these elements. The length of the vector is computed by adding up the distances between each of the vector's element as follows:

$$l = {\sum }_{i = 0}^{i = n} l \vert ( P ( i \vert 1 ) P ( i ) )$$

where l is the length of the contour vector and n is the total number of the elements. The average length between two adjacent elements is then given by:

$${l}_{av} = \frac{l}{n}$$

The contour is then re-parameterized by using Iₐᵥ as the distance between each element, by which the elements of the resulting contour have an equal spatial distance between them.

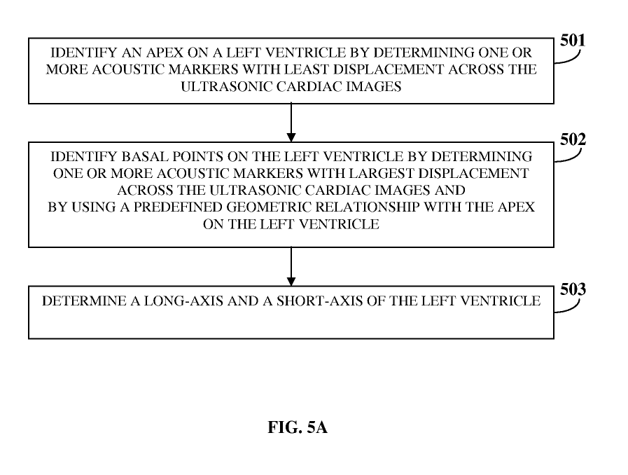

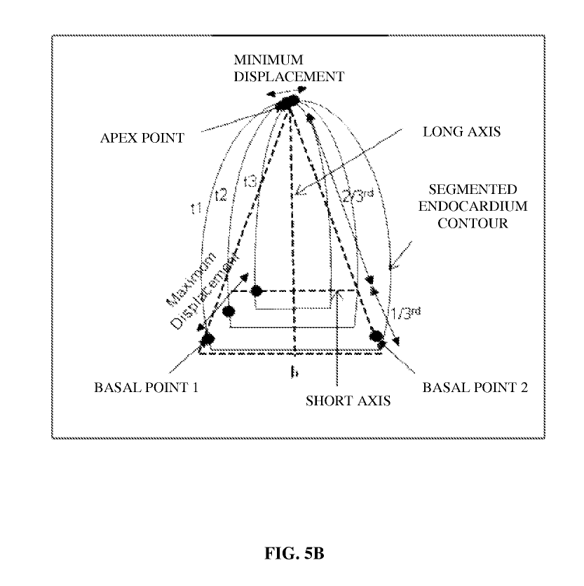

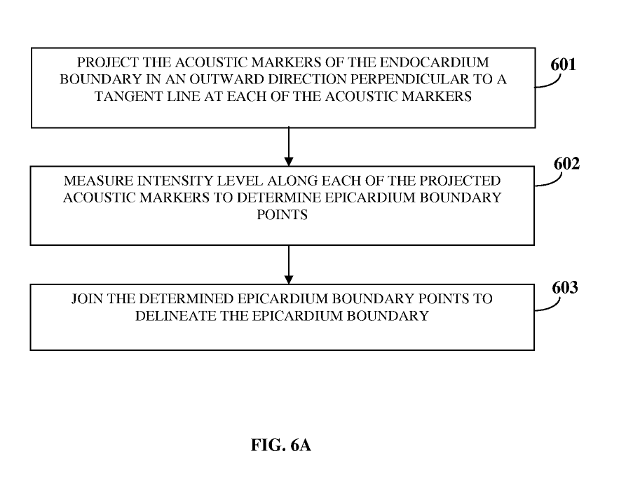

FIG. 5A exemplarily illustrates a computer implemented method for identifying an apex and basal points on the left ventricle and determining a long-axis and a short-axis of the left ventricle. The ventricular apex is identified 501 by determining the acoustic Markers with least displacement across the ultrasonic cardiac images. The ventricular apex has negligible movement during a cardiac cycle compared to the rest of the ventricle. As such, the point(s) on the ventricle that have the least displacement are marked as the ventricular apex. FIG. 5B exemplarily illustrates endocardium displacement at successive times, for example, t1, t2 and t3. FIG. 5B also illustrates positions of the apex and the basal points, and the minimal and maximal displacements of the apex and basal points respectively. As illustrated in FIG. 5B, the apex point is displaced the least and the basal points are displaced the most. The acoustic markers are tracked for FPS/2 frames, where FPS is the frame-rate per second of the echocardiogram. The time period, FPS/2, is sufficient for determining the points on the ventricle that have the least movement. After tracking the acoustic markers for FPS/2 frames, the point(s) that have the least displacement is identified as the ventricular apex.

The basal points of the ventricle are estimated based on the fact that the basal points exhibit maximum displacement during a cardiac cycle as exemplarily illustrated in FIG. 5B. The points that have the maximal displacements across the ultrasonic cardiac images over a cardiac cycle are marked or identified 502 as the basal points. To eliminate cases where the points exhibiting maximum displacement are actually not the basal points, the basal points of the left ventricle are identified 502 based on a predefined geometric relationship with the apex of the left ventricle. The left ventricle can be approximated as an isosceles triangle. The re-parameterized segmented endocardium contour is divided in the ratios corresponding to the sides of an isosceles triangle, with the apex point as the apex of the isosceles triangle. A perpendicular is drawn from the apex till it intersects the contour at the base of the isosceles triangle. This forms the mid point of the base of the isosceles triangle. If the estimated basal points are connected by a line, this line segment is then the base “b” of the isosceles triangle, as exemplarily illustrated in FIG. 5B. Any point or points that display maximum displacement, but are not located in the vicinity of the end-points of the base “b” are rejected. This ensures accurate estimation of the basal points.

The long-axis and the short-axis of the left ventricle are determined 503. The long-axis of the left ventricle is determined as the line segment that joins the apex of the left ventricle and the mid point of the base line segment. The short-axis is determined by a predetermined geometric interpolation between the apex and basal points. The short-axis is determined by joining points that are at ⅔rd the distance from the apex to the basal points.

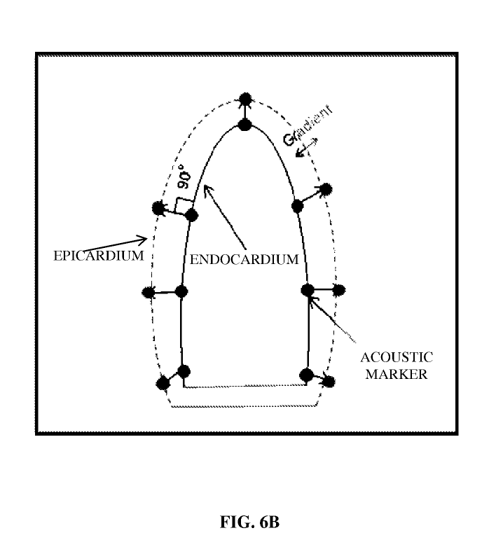

The re-parameterized contour is then segmented into, for example, six segments, according to the American Society of Echocardiography's (ASE's) guidelines. The apex-to-basal point and apex-to-basal point 2 segments are divided into six segments as exemplarily illustrated in FIG. 6B. The identified 7 acoustic markers that constitute the six ventricular segments are then tracked by the tracking engine for estimating the cardiac parameters.

FIG. 6A exemplarily illustrates a computer implemented method for delineating an epicardium boundary. The epicardium boundary is segmented using the segmented or delineated endocardium boundary. The acoustic markers of the endocardium boundary are projected 601 outwardly in a direction perpendicular to a tangent line at each of the acoustic markers. FIG. 6B exemplarily illustrates these projections on the segmented endocardium contour. The intensity level along each of the projected acoustic markers is measured 602 by traversing the projections to determine epicardium boundary points, where a sharp gradient is encountered at the epicardium boundary. The epicardium boundary points define a specific range of intensity gradients on the traversed projections. The determined epicardium boundary points are joined 603 for segmenting or delineating the epicardium boundary.

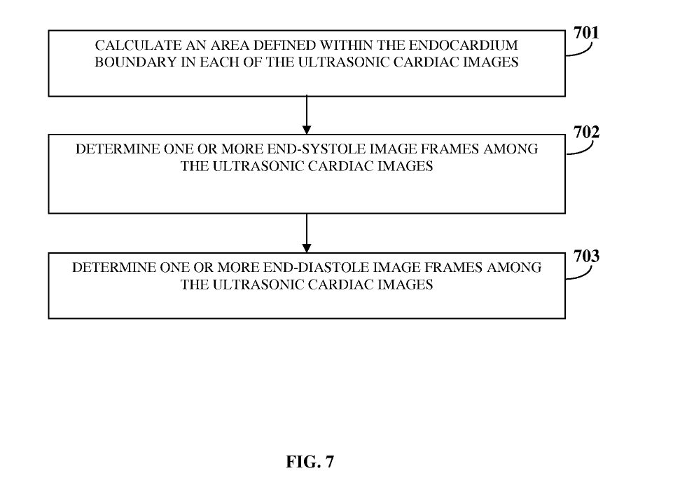

One or more periodic stages of each of the cardiac cycles, for example, in terms of the systolic and diastolic image frames are determined. FIG. 7 exemplarily illustrates a computer implemented method for determining one or more periodic stages of the cardiac cycles. The localized region based AC segmentation is applied to all the image frames of the echocardiogram. For each segmented image frame, the area enclosing the endocardium boundary is calculated 701 by counting the total number of pixels within the segmented endocardium contour. The end-systole image frames among the segmented ultrasonic cardiac images are determined 702 or isolated, wherein the end-systole image frames define a minimum area within the endocardium boundary. The end-diastole image frames among the segmented ultrasonic cardiac images are determined 703 or isolated, wherein the end-diastole image frames define a maximum area within the endocardium boundary. This information allows the computation of the total number of cardiac cycles by summing the total number of systole or diastole image frames:

Total cardiac cycles=Σ(systole or diastole) frames

In an embodiment, the frequency of the periodicity of the cardiac cycles is determined using a fast Fourier transform (FFT) algorithm and is used to determine the end-systole and/or end-diastole image frames. The input to the FF1 is the data that is output by tracking the acoustic markers. The instantaneous heart beat rate and an average heart beat rate is calculated by determining frequency of the cardiac cycles based on recurrence of one or more of the end-systole image frame pairs and the end-diastole image frame pairs. For example, the instantaneous heart beat rate is calculated by determining the time elapsed between a pair of end-systole image frames or a pair of end-diastole image frames. The instantaneous heart beat rate is given by:

$${H}_{i} = \frac{Total Cardiac Cycles}{Δ T} Hz ( cycles \text{/} sec )$$

where ΔT is the time elapsed between a systole or a diastole image frame-pair.

The average heart beat rate is given by:

$${H}_{a} - \frac{Total Cardiac Cycles}{T} Hz$$

where T is the total duration of the echocardiogram, which is obtained from the header of an echocardiogram file obtained from an echocardiogram database.

The acoustic markers identified on the segmented endocardium are tracked using object tracking algorithms. These algorithms are commonly referred to as speckle tracking echocardiography (STE), when they are applied to track the acoustic markers for tissue tracking.

The underlying principle of STE is that the ultrasound waves reflected from the ventricular tissue give rise to an irregular and random speckle-pattern. This speckle-pattern is unique, similar to a fingerprint, in a small region on the tissue and is termed as kernel. When the tissue moves during a cardiac cycle, the position of this kernel shifts slightly, but remains fairly constant between two subsequent image frames. The position of the kernel remains constant, provided the time period between two successive image frames is below a certain threshold. An object tracking algorithm is then used to search or track this kernel between a given frame fₜ and the subsequent frame fₜ₊ₗ. These kernels are the acoustic markers, identified with reference to FIG. 4C. However, if the time period between two image frames is above a certain threshold, the speckle-pattern of these acoustic markers between those two image frames is no longer the same and cannot be tracked.

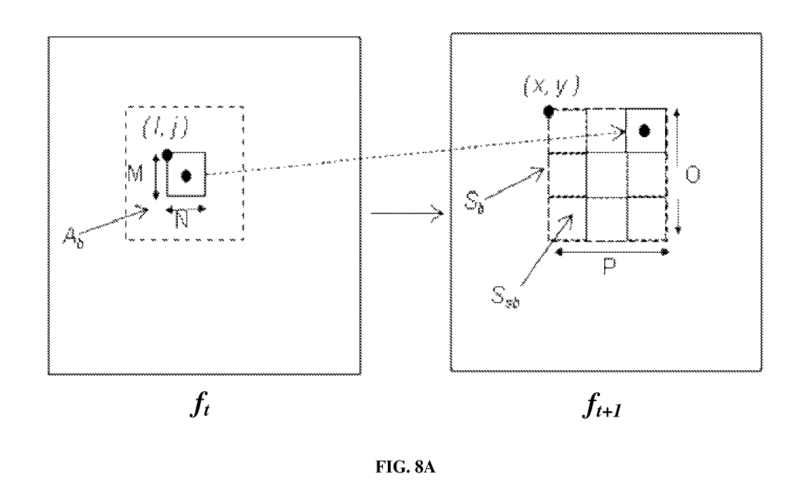

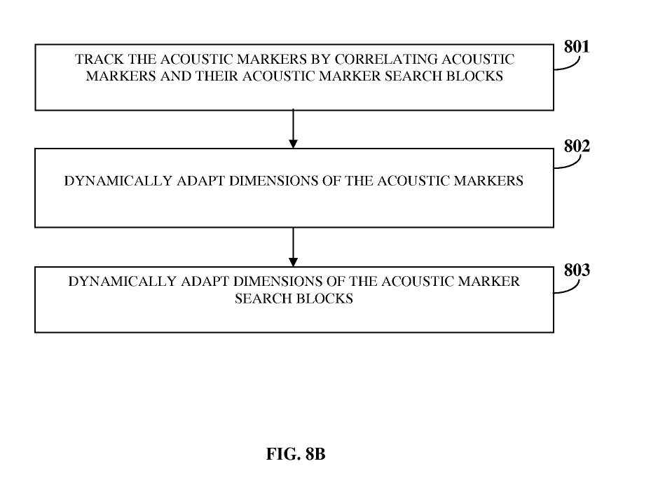

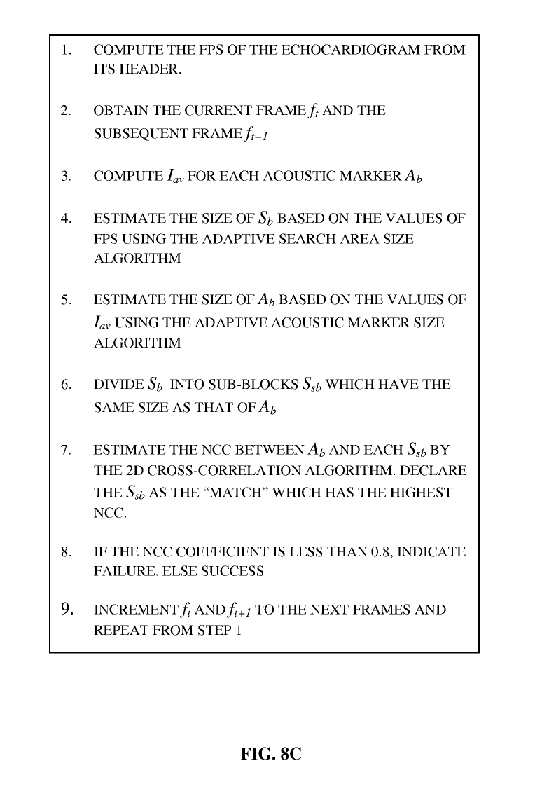

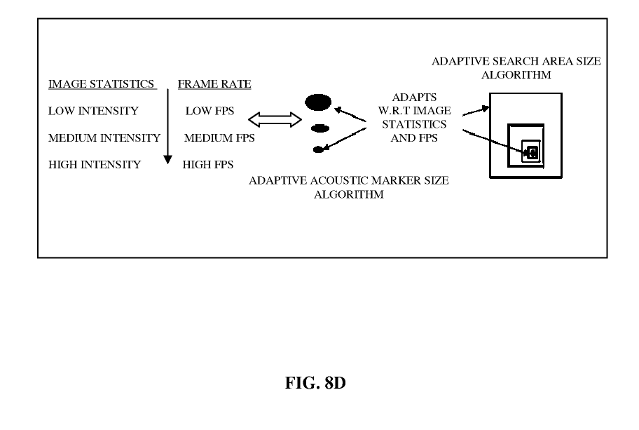

The acoustic markers are tracked by correlating the acoustic markers and their respective acoustic marker search blocks between a current ultrasonic cardiac image and a subsequent ultrasonic cardiac image. The acoustic marker search blocks are employed for searching the acoustic markers on each of the ultrasonic cardiac images. As exemplarily illustrated in FIG. 8A, an acoustic marker block A_{b} is defined as a block of dimension N×M pixels in frame fₜ with the acoustic marker pixel at the center of the acoustic marker block. FIG. 8A exemplarily illustrates tracking of an acoustic marker between successive ultrasonic cardiac images. The area in the subsequent frame fₜ₊ₗ, where A_{b} is to be searched is defined as the search block S_{b} of dimension O×P pixels. This search block is further divided into sub-blocks S_{sb}, each of which has the same size as that of the acoustic marker block A_{b}. To search for the acoustic marker in frame fₜ₊ₗ, that is, to track 801 the acoustic marker, the acoustic marker block A_{b} is cross correlated using a two dimensional (2D) cross correlation algorithm with each sub-block S_{sb}. The sub-block that results in the highest correlation or the best match is declared as the tracked position of A_{b} in the frame fₜ₊ₗ.

This tracking process is performed for each of the seven acoustic markers across all the image frames in the echocardiogram. The result of this tracking is essentially the amount of displacement that each acoustic marker undergoes during a cardiac cycle. This displacement is used to calculate the cardiac parameters.

The 2D cross correlation algorithm used for tracking is a normalized cross correlation (NCC) algorithm defined as follows:

$$N C C = \frac{( {\sum }_{x = 1}^{M} {\sum }_{y = 1}^{N} ( l [ i + x , j + y ] - {l}_{av} ) * ( {l}^{′} [ k + x , l + y ] - {l}_{av}^{′} ) )}{\sqrt{( {\sum }_{x = 1}^{M} {\sum }_{x = 1}^{N} {( l ⌊ i + x , j - y ⌋ - {l}_{av} )}^{2} ) * ( {\sum }_{x = 1}^{M} {\sum }_{x = 1}^{N} {( {l}^{′} ⌊ k + x , l + y ⌋ - {I}_{av}^{′} )}^{2} )}}$$

where NCC is the normalized cross correlation coefficient,

Iₐᵥ and I′ₐᵥ are the average intensities of A_{b} and S_{sb} respectively,

(i, j) and (x, y) are the top left corner coordinates of A_{b} and S_{b}, respectively.

The ideal value of the NCC coefficient is 1. Based on visual observations, the typical values of the NCC coefficient for successfully tracking the acoustic markers across two subsequent frames fall in the range of, for example, 0.8-0.99. The NCC coefficient is sensitive to the FPS of the echocardiogram and the quality of the speckle-statistics, that is, the speckle-pattern. These variables in-turn dictate the sizes for A_{b} and S_{b}.

For a given pair of successive frames in an echocardiogram, a low value of FPS implies that the time duration between the two successive frames is more compared to a high value of FPS. In effect, the acoustic marker traverses a larger distance between two successive frames at low FPS, compared to the distance traversed by the acoustic marker at high FPS. This in turn implies that, at low FPS, the acoustic marker needs to be searched in a larger area, that is, in a larger S_{b}. The relationship between FPS and S_{b} is inversely proportional:

$${S}_{b} ≅ \frac{1}{F P S}$$

The acoustic markers can be successfully tracked (i.e. NCC ˜0.8-0.99) only if the time period between two successive frames is below a certain threshold. If the time period or the equivalent FPS is above this threshold, de-correlation can occur (i.e. NCC<0.8), which results in a tissue tracking failure. Based on visual observations of acoustic marker tracking, the range for appropriate frame rate is, for example, 50-80 FPS, depending on the type of ultrasound scanner.

The quality of the speckle-pattern, essentially the speckle-statistics, is determined by the ultrasound scanner. New generation ultrasound scanners that have high quality transducers and digital beam-formers, render high quality echocardiograms, which exhibit high quality speckle-statistics. The computer implemented method disclosed herein uses the average intensity Iₐᵥ as a measure of the speckle-statistics quality. Iₐᵥ is a statistical measure that approximates the speckle-statistics well and is easy to compute:

$${I}_{av} = \frac{{\sum }_{i = 0}^{i = N - 1} P ( i )}{( N - 1 )}$$

where N is the total number of pixels in a given acoustic marker block A_{b}.

Given a typical intensity range of 0-255 for grayscale image frames, it is considered that the speckle-statistics quality is low if the value of Iₐᵥ falls in the range of 80-100, and high if the value of Iₐᵥ is in the range of 175-200.

Based on visual observations of the acoustic marker tracking, Iₐᵥ depends on the size of the acoustic marker block A_{b}, to some extent, owing to the fact that a larger block-size contains more speckles. A larger block size effectively increases the overall intensity level. As such, the size of A_{b} can be increased to a certain level to achieve the desired Iₐᵥ. Their relationship is directly proportional as follows:

Iₒₙ≅A_{b}

The computer implemented method disclosed herein employs an adaptive speckle tracking algorithm for tracking acoustic markers across the ultrasonic cardiac images. FIG. 8B exemplarily illustrates an adaptive method of tracking acoustic markers across the ultrasonic cardiac images. The dimensions of the acoustic marker block A_{b} and the acoustic maker search block S_{b} are dynamically adapted 802 and 803 throughout all the cardiac cycles based on the values of Iₐᵥ and FPS respectively. For example, the higher the image intensity, the smaller is the size of the acoustic marker block A_{b}. Similarly, the higher the FPS, the smaller is the size of the acoustic marker search block S_{b}. For a given echocardiogram, the FPS remains constant, but the value of Iₐᵥ varies across the ventricular tissue segments. Iₐᵥ can also vary at the same spatial location on the ventricle, across different frames. For example, the tissue segment near the apex point can have different values of Iₐᵥ as compared to the segment near the basal points. Also, the value Iₐᵥ at a specific location, for example, the apex point can vary between two image frames.

FIG. 8C exemplarily illustrates a pseudocode for an adaptive speckle tracking algorithm. The algorithms for adaptive acoustic marker size and the adaptive search area size are defined by the pseudocode, which dynamically updates A_{b} and S_{b} with respect to Iₐᵥ and FPS respectively. These algorithms parse a lookup table that contains the values of A_{b} and S_{b} for different Iₐᵥ and FPS values. The FPS of the echocardiogram is computed from the header of the echocardiogram. The current frame fₜ and the subsequent frame fₜ₊ₗ are obtained. The image intensity Iₐᵥ is computed for each acoustic marker A_{b}. The size of S_{b} is estimated based on the values of FPS using the adaptive search area size algorithm. The size of A_{b} is estimated based on the values of Iₐᵥ using the adaptive acoustic marker size algorithm. The search block S_{b} is divided into sub-blocks S_{sb}, each having the same size as that of A_{b}. The NCC between A_{b} and each S_{sb} is estimated by the 2D cross-correlation algorithm. The S_{sb} that has the highest NCC is declared as the match. Based on the value of the NCC coefficient compared to the threshold of 0.8, the success or failure of the acoustic marker tracking is indicated. The values fₜ and fₜ₊ₗ are incremented to the next image frames, and the steps are repeated.

FIG. 8D exemplarily graphically illustrates implementation of the adaptive speckle tracking algorithm. The adaptive speckle algorithm makes the acoustic marker tracking highly robust. If the sizes of A_{b} and S_{b} are not made adaptive, it can lead to tracking failure due to fluctuating speckle-statistics Iₐᵥ. Moreover, though the FPS is constant for a given echocardiogram, the FPS can vary with different echocardiograms. As such, a static value of A_{b} and S_{b}, may not guarantee a successful tracking for all echocardiograms. Therefore, the adaptive speckle tracking algorithm disclosed in the detailed description of FIGS. 8B-8D increases the accuracy and robustness of the acoustic marker tracking.

In an embodiment, the 2D correlation algorithm used in the computer implemented method disclosed herein is the sum of absolute differences (SAD) algorithm. The SAD algorithm yields results similar to the 2D correlation algorithm.

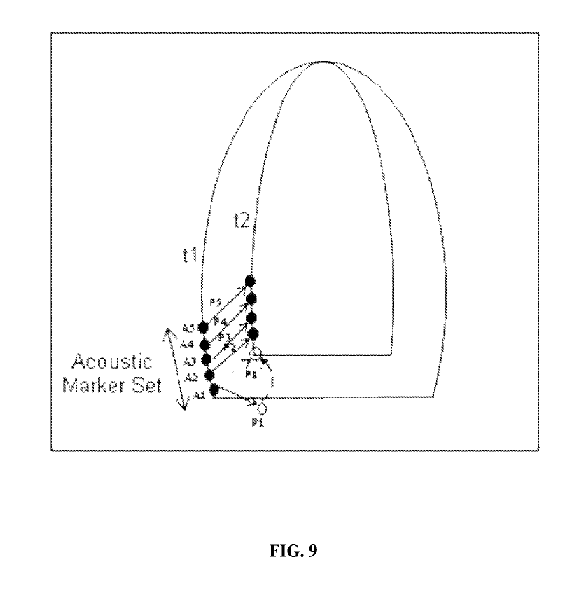

Though the adaptive speckle tracking algorithm disclosed in the detailed description of FIGS. 8B-8D increases the accuracy and robustness of the acoustic marker tracking, the tracking is made more robust by a synthetic phase algorithm, which overcomes factors such as excessive noise in the ultrasonic cardiac images or a FPS below the threshold of 30 FPS. In the synthetic phase algorithm, a set of 2 to 4 acoustic markers are defined adjacent to a given acoustic marker. In the normal tracking mode, a total of 7 acoustic markers are defined, which corresponds to six tissue segments according to the ASE's parametric imaging guidelines. If each acoustic marker set comprises 5 acoustic markers, a total number of 35 acoustic markers are available. The synthetic phase component is constructed for further improving the tracking of the acoustic markers. FIG. 9 exemplarily illustrates the synthetic phase algorithm. As illustrated in FIG. 9, a basal acoustic marker, named A1 is supplemented by four additional acoustic markers, namely A2 to A5, to create an acoustic marker set.

This acoustic marker set A1-A5 is then tracked as disclosed in the detailed description of FIGS. 8A-8D. A resultant displacement of each adjacent acoustic marker in the acoustic marker set is calculated in terms of individual phase components. This displacement is a vector having magnitude and direction components. The direction component is defined as the phase component of the acoustic marker. The acoustic markers A1 to AS in the acoustic marker set are tracked from frame 1, represented by time t1, to frame 2, represented by time t2. The arrows in FIG. 9 represent the displacement vector. As illustrated in FIG. 9, the phase P1 of vector A1 is incorrectly oriented towards a bottom-right direction, while the phases of rest of the vectors A2-A5 are oriented towards a top-right direction. The vector A1 is pointing towards the bottom-right direction, possibly due to a tracking failure. Consequently, the synthetic phase algorithm considers the phase that is in majority among all the phases (P1-P5). As illustrated in FIG. 9, phases of vectors A2 to A5 are in majority, as these phases point in the same top-right direction. As such, the effective phase component or a synthetic phase component is constructed based on the orientation of the majority of the individual phase components.

The synthetic phase algorithm is based on the rationale that the displacement of a small tissue segment on the ventricle is in the same direction. Since each acoustic marker set represents a small tissue segment, all the acoustic markers in the acoustic marker set necessarily have the same displacement in the same direction. As illustrated in FIG. 9, the incorrect phase P1 of vector A1 is corrected by updating the vector to a phase P1′ using the constructed synthetic phase component. The spacing between the acoustic markers in the acoustic marker set is about 1-2 pixels for ensuring that the acoustic markers represent a small tissue segment. The synthetic phase algorithm ensures that any acoustic marker that undergoes a tracking failure is corrected based on the synthetic phase component.

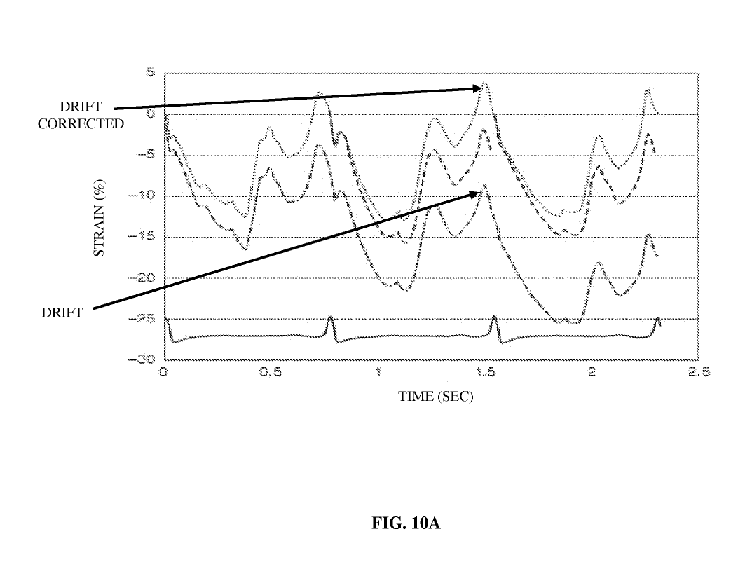

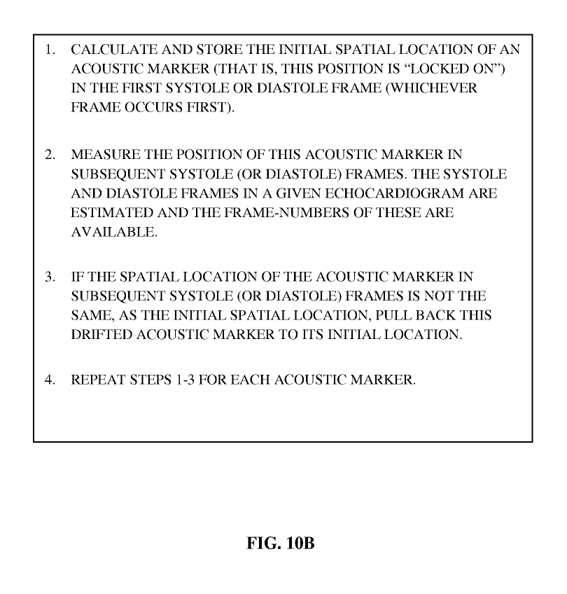

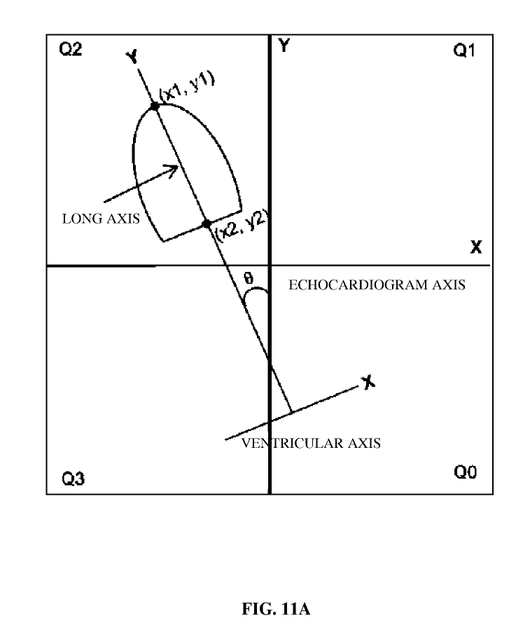

While tracking an acoustic marker, a phenomenon called “drift” can occur due to jitters in a cardiac ultrasound probe, uneven breathing-rhythm or the movement of the patient, etc. Drift is an example of a movement artifact in the cardiac ultrasound. The effect of these can result in the acoustic marker gradually drifting away from its actual position over a period of few cardiac cycles. Typically, the displacement graph or the graph of the cardiac parameters derived from the displacement, of an acoustic marker over the cardiac cycles should be periodic. This is due to the fact that the cardiac cycle is a periodic phenomenon and as such, each point on the ventricle is expected to exhibit a periodic behavior. However, due to the drift phenomenon, the graph starts varying as exemplarily illustrated in FIG. 10A. FIG. 10A exemplarily illustrates a strain graph showing drift compensation in the ultrasonic cardiac images. The strain graph shows the drift and correction of this drift by the compensation or lock-on algorithm.

As the drift is gradual and is spread across a few cardiac cycles, the calculated value of the NCC coefficient, falling within the range of 0.9-0.99, may not indicate the occurrence of the drift phenomena. The fact that the ventricle exhibits a periodic motion is used to correct the drift condition. An acoustic marker, which represents a small tissue segment, has to regain its initial position after a time period, approximately equal to 1/(cardiac cycle frequency). This essentially means that the acoustic marker regains the same spatial location at every systole or diastole frame in each cardiac cycle. The drift is compensated by shifting location or correcting the position of the acoustic marker on each subsequent end-systole image frame towards one or more reference acoustic markers, reflecting the acoustic marker's initial position on the first end-systole image frame. In another embodiment, the drift is compensated by shifting the location of each acoustic marker on each subsequent end-diastole image frame towards one or more reference acoustic markers, reflecting the acoustic marker's initial position on the first end-diastole image frame. The graph in FIG. 10A shows the effect on the strain graph when the graph is drift corrected using the lock-on algorithm. The lock-on algorithm corrects the position of an acoustic marker in a systole or diastole frame, if the acoustic marker has drifted away from its original position. FIG. 10B exemplarily illustrates a pseudocode for a drift compensation algorithm, namely the lock-on algorithm. This drift correction is performed for each of the 7 identified acoustic markers. The initial spatial location of an acoustic marker is calculated and stored, that is the position of the acoustic marker is “locked on” in the first systole or diastole image frame, whichever image frame occurs first. The position of this acoustic marker in subsequent systole or diastole image frames is measured. The systole and diastole image frames in a given echocardiogram are estimated and the frame numbers of these images are recorded. If the spatial location of the acoustic marker in a subsequent systole or diastole image frames is not the same as the initial spatial location, the drifted acoustic marker is shifted or pulled back to the initial location. These steps for drift compensation are repeated for each acoustic marker.

The result of the acoustic marker tracking is essentially the displacement that a tissue segment, represented by one or more acoustic markers, undergoes during a cardiac cycle. The displacement of the tissue segment, which is a cardiac parameter, is used to derive other cardiac parameters. As disclosed in the detailed description of FIG. 9, the displacement is available as a vector having magnitude and phase components. In cardiac functional assessment, this displacement vector is broken down into two components, namely the longitudinal and radial components, which correspond to the projection of the vector on the Y axis and X axis respectively. The estimation of these longitudinal and radial components is straightforward if the ventricular axis is the same as the echocardiogram axis. However, in most cases the ventricle can have a tilt with respect to the echocardiogram axis. As a result, the ventricle has to be aligned with the echocardiogram axis before computation of the longitudinal and radial components.

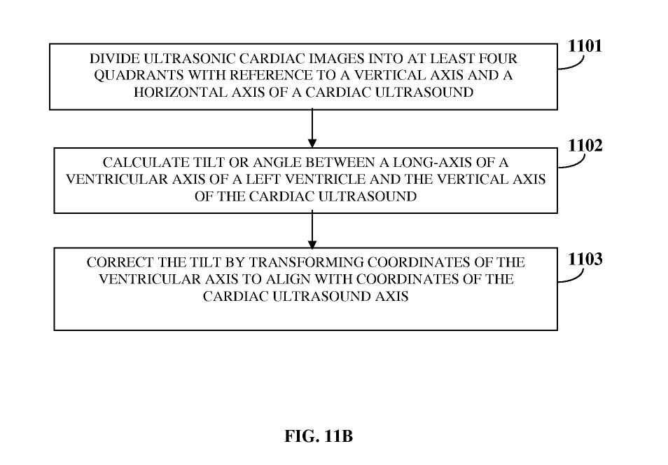

The computer implemented method disclosed herein estimates and corrects the tilt in each of the ultrasonic cardiac images using, for example, slope and rotational matrix algorithms. This allows quantification of echocardiograms whose coordinate axis is not aligned with the axis of the ultrasound scanner. The tilt or the angle between the long-axis of the left ventricle and the vertical or Y axis of the echocardiogram is calculated from the delineated endocardium boundary. The tilt is automatically estimated by calculating the slope of the long-axis of the ventricular axis and consequently calculating the angle by which the ventricle is tilted. As illustrated in FIG. 11A, the long-axis of the left ventricle estimated earlier, approximates the Y component of the ventricular axis and its slope m is calculated as follows:

$$m = \frac{y 2 - y 1}{x 2 - x 1}$$

where (y1, y2) and (x1, x2) are the spatial coordinates of the long-axis.

The angle is then calculated as follows:

$${θ}_{t} = ( {tan}^{1} m ) * \frac{π}{180} degrees$$

FIG. 11B exemplarily illustrates a computer implemented method for estimating and correcting tilt in the ultrasonic cardiac images. The ultrasonic cardiac images are divided 1101 into at least four quadrants with reference to a vertical axis and a horizontal axis of a cardiac ultrasound. The tilt or angle between the long-axis of a ventricular axis of the left ventricle and the vertical axis of the cardiac ultrasound axis is calculated 1102. The tilt angle is corrected 1103 by transforming coordinates of the ventricular axis to align with coordinates of the cardiac ultrasound axis. The ventricle is aligned to the echocardiograph axis by multiplying the coordinates of the long-axis using the standard rotational matrix as follows:

$$[ \begin{matrix}{x}^{′} \\ {y}^{′}\end{matrix} ] = [ \begin{matrix}cos {θ}_{t} & - sin {θ}_{t} \\ sin {θ}_{t} & cos {θ}_{t}\end{matrix} ] [ \begin{matrix}x \\ y\end{matrix} ]$$

After correcting the tilt, the longitudinal and radial displacement components of the displacement vectors are estimated by taking the projection of the displacement vector on the echocardiographic Y axis and X axis, respectively.

The cardiac parameters, for example, tissue displacement, tissue velocity, tissue strain, tissue strain rate, ventricular volume, and ventricular ejection fraction are then automatically calculated based on known relationships between the cardiac parameters. For each tissue segment, the values of the cardiac parameters are calculated with respect to the parametric imaging model as per the ASE guidelines. The cardiac parameters are calculated, for example, for 1-5 cycles at 80-100 FPS in about 2 minutes.

Tissue displacement is the amount of displacement D in centimeters that a specific acoustic marker undergoes during a cardiac cycle. The displacement is calculated by tracking the acoustic markers using the adaptive tracking algorithm as disclosed in the detailed description of FIGS. 8A-8D. All the components, for example, absolute, longitudinal and radial components of the displacement are calculated for all the six segments in the parametric format and the graphical format.

Tissue velocity is defined as the amount of displacement that an acoustic marker undergoes within a given duration. The tissue velocity V is calculated as follows:

$$V = \frac{Δ D}{Δ t} cm / sec$$

where Δt is the time difference between two successive image frames. The absolute, longitudinal and radial components of velocity are calculated for all the six segments in the parametric format and the graphical format.

Tissue strain is defined as the percentage of deformation that a specific tissue segment undergoes in a given duration of time. If the original length of the tissue segment is defined by L₀ and the length after the deformation is defined by L, the tissue strain ε is given by:

$$ɛ = \frac{{L}_{n} - L}{{L}_{0}}$$

The length of the tissue segment is estimated by measuring the distance between two adjacent acoustic markers. The absolute, longitudinal and radial components of strain are calculated for all the six segments in the parametric format and the graphical format.

Tissue strain rate \acute{ε} is defined as the rate at which tissue deformation occurs, that is, the rate of change of tissue strain in a given duration of time, and is given by:

$${ɛ}^{′} = \frac{Δɛ}{Δ t} {s}^{- 1}$$

The absolute, longitudinal and radial components of strain rate are calculated for all the six segments in the parametric format and the graphical format.

Ventricular volume is the volume in milliliters (ml) of the ventricle at a given instant of time. Ventricular volume is calculated using the standard Prolate Ellipsoid or Simpson's rule for numerical integration.

The ventricular ejection fraction (EF) is defined as the percentage of blood that is pumped out in a given cardiac cycle. Ventricular EF is calculated as follows:

$$E F = \frac{( E D V - E S V )}{E D V} * 100 \%$$

where EDV and ESV are end-diastolic volume and end-systolic volume respectively.

In another embodiment, the localized region based AC algorithm can be used to calculate the volume and EF parameters. Here, the ventricular volume can be directly calculated by computing the area of the segmented endocardium. The area can be estimated by summing the pixels in the contour that segments the echocardiogram. The estimated area is equated to the actual volume that is calculated using the Prolate Ellipsoid or Simpsons rule. This is performed as a calibration step and is represented as follows:

Volume (Prolate/Simpsons method)=x*Contour area (segmentation method),

where x is the calibration factor and is a constant.

The calibration factor x is then:

$$x = \frac{Volume ( Prolate / Simpsons method )}{Contour Area ( segmentation method )}$$

Thereafter, x is used as a multiplicative factor in calculating the volume using the segmentation method. The area of the segmented endocardium is calculated using the segmentation method and multiplied by the calibration factor x as follows:

Volume (segmentation method)=x*Area (segmentation method)

This embodiment for calculating the volume and EF is simpler as computations of the long-axis and short-axis and the entire speckle tracking echocardiography can be eliminated. However, this requires a calibration step and other cardiac parameters cannot be reliably calculated.

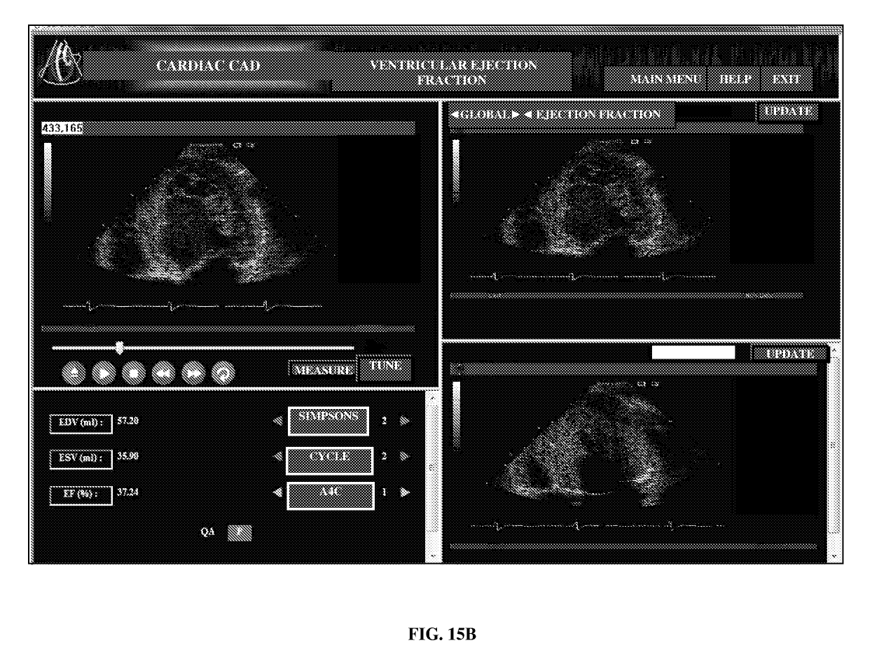

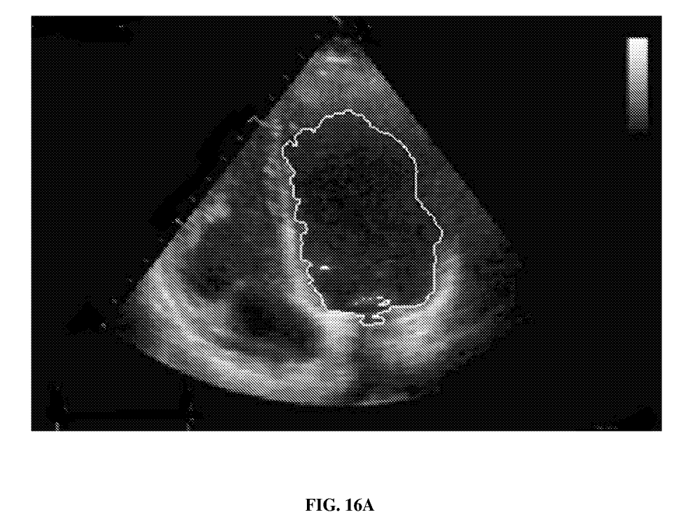

The computer implemented method and system disclosed herein easily calculates other cardiac parameters, as specified by cardiologists, as these cardiac parameters can be made derivatives of the presently quantified cardiac parameters. For example, the tissue velocity parameter is derived from tissue displacement using the formula Velocity=Displacement/Time. Similarly, other new parameters can be derived from the quantified cardiac parameters. The cardiac parameters are displayed in a parametric format and/or a graphical format on a graphical user interface as exemplarily illustrated in FIGS. 15A-15B. By way of employing the segmentation and adaptive tracking algorithms disclosed herein, the computer implemented method and system disclosed herein allows cardiologists to perform a fully-automatic cardiac functional assessment, without requiring any manual intervention or inputs.

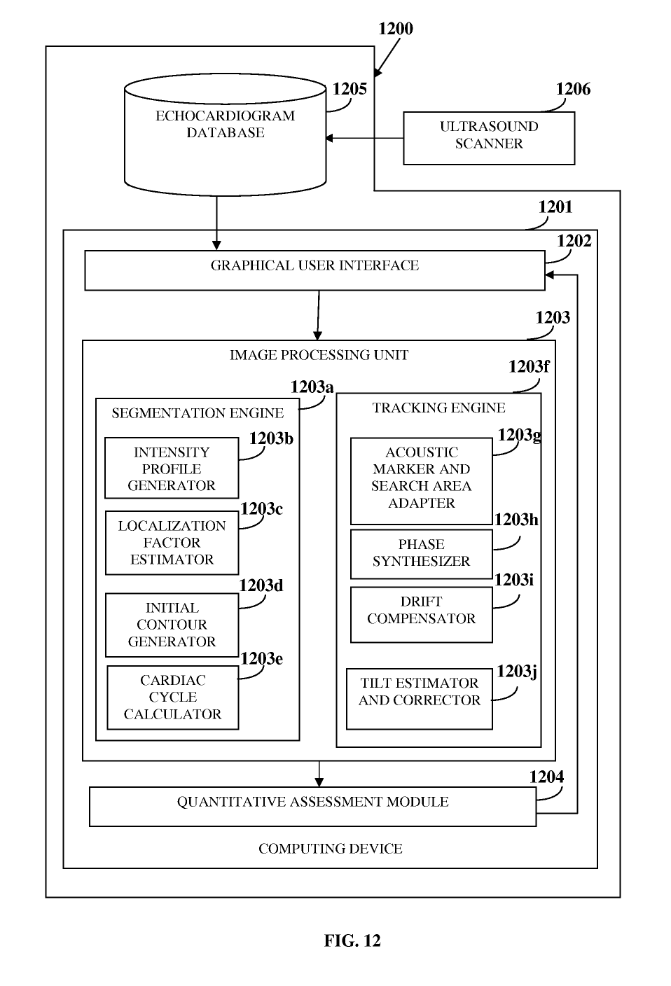

FIG. 12 illustrates a computer implemented system 1200 for automatic cardiac functional assessment using a series of ultrasonic cardiac images. The computer implemented system 1200 disclosed herein comprises a computing device 1201, for example, a personal computer, a laptop, etc., and an echocardiogram database 1205 connected to an ultrasound scanner 1206, for example, in an online mode. The computing device 1201 comprises a graphical user interface (GUI) 1202, an image processing unit 1203, and a quantitative assessment module 1204. The frontend of the computer implemented system 1200 is the GUI 1202, which is developed using, for example, C++ programming language. The GUI 1202 allows users to upload an echocardiogram from the echocardiogram database 1205 to the computing device 1201. The GUI 1202 allows a user to open an echocardiogram file from the echocardiogram database 1205 and extract image frames from the echocardiogram file. The GUI 1202 also displays the calculated cardiac parameters in a parametric format and/or a graphical format. The backend of the computer implemented system 1200 disclosed herein comprises the image processing unit 1203 and the quantitative assessment module 1204, which are developed using programming languages, for example, C programming language for image segmentation, tracking, and cardiac parameter computation.

The GUI 1202 allows uploading of echocardiograms in, for example, audio video interleave (AV1) format, motion picture experts group (MPEG) format, digital imaging and communications in medicine (DICOM) format, etc. from the echocardiogram database 1205 and displays the quantified cardiac parameters in a parametric format and a graphical format. The echocardiogram database 1205 resides either in a hard disk drive (HDD) of the computing device 1201 or on a remote networked HDD. The image processing unit 1203 retrieves the echocardiogram from the GUI 1202 for processing.

The image processing unit 1203 provided on the computing device 1201 comprises a segmentation engine 1203a and a tracking engine 1203f. The segmentation engine 1203a performs automatic segmentation of each of the ultrasonic cardiac images from the echocardiogram for delineating the endocardium boundary using the segmentation algorithm, for example, the region-based AC algorithm. The segmentation engine 1203a further performs automatic segmentation of the epicardium boundary using the delineated endocardium boundary. The segmentation engine 1203a comprises an intensity profile generator 1203b, a localization factor estimator 1203c, an initial contour generator 1203d, and a cardiac cycle calculator 1203e. The segmentation engine 1203a locates and identifies multiple acoustic markers on the endocardium boundary of the ultrasonic cardiac image and identifies the apex and basal points using the intensity profile generator 1203b, the localization factor estimator 1203c, and the initial contour generator 1203d. The intensity profile generator 1203b generates multiple intensity profile vectors on one or more of the ultrasonic cardiac images. The localization factor estimator 1203c generates the localization factor required to perform the segmentation of the ultrasonic cardiac images, using the intensity profile vectors. The initial contour generator 1203d generates an initial contour, also required to perform the segmentation, using the results of the intensity profile generator 1203b. The cardiac cycle calculator 1203e calculates the total number of cardiac cycles, the instantaneous heart beat rate, and the average heart beat rate by determining the frequency of the cardiac cycles based on the recurrence of the end-systole image frame pairs and/or the end-diastole image frame pairs.

The tracking engine 1203f tracks the identified acoustic markers across the ultrasonic cardiac images over multiple cardiac cycles using the adaptive speckle tracking algorithm. The tracking engine 1203f comprises an acoustic marker and search area adapter 1203g, a phase synthesizer 1203h, a drift compensator 1203i, and a tilt estimator and corrector 1203j. The acoustic marker and search area adapter 1203g dynamically adapts the dimensions of the acoustic markers and the acoustic marker search blocks with respect to the image intensity and FPS, respectively, for tracking the acoustic markers. For example, the higher the image intensity, the smaller is the size of the acoustic marker block. Similarly, the higher the FPS, the smaller is the size of the acoustic marker search block. The phase synthesizer 1203h constructs a synthetic phase component for tracking the acoustic markers. The phase synthesizer 1203h calculates a resultant displacement of each of a set of adjacent acoustic markers in terms of individual phase components and constructs the synthetic phase component for the set of adjacent acoustic markers based on the orientation of a majority of the individual phase components. The drift compensator 1203i compensates for movement artifacts, for example, drift in the ultrasonic cardiac images by shifting the location of the acoustic markers on the ultrasonic cardiac images, at each subsequent periodic stage, towards one or more reference acoustic markers located during the first periodic stage. In an example, the drift compensator 12031 compensates for drift in the ultrasonic cardiac images by shifting the location of the acoustic markers on each subsequent end-systole image frame towards one or more reference acoustic markers located on the first end-systole image frame. In another example, the drift compensator 1203i compensates for drift in the ultrasonic cardiac images by shifting the location of the acoustic markers on each of subsequent end-diastole image frame towards one or more reference acoustic markers located on the first end-diastole image frame. The tilt estimator and corrector 1203j estimates and corrects a tilt in each of the ultrasonic cardiac images for calculating longitudinal and radial components of the calculated cardiac parameters. The quantitative assessment module 1204 calculates the cardiac parameters using the tracked acoustic markers on the ultrasonic cardiac images. The quantitative assessment module 1204 passes the calculated cardiac parameters to the GUI 1202 for display. The computing device 1201 displays the cardiac parameters in a parametric format and a graphical format using the GUI 1202.

The computer implemented method and system 1200 disclosed herein pertains to an automatic offline (PC based) cardiac functional assessment system 1200. In an embodiment, the computer implemented system 1200 can be restructured to operate in an online cardiac functional assessment mode. In the online cardiac functional assessment mode, the computer implemented system 1200 disclosed herein can be interfaced with an ultrasound scanner 1206 via a universal serial bus (USB) port on the ultrasound scanner 1206. When the ultrasound scanner 1206 captures the echocardiogram, the echocardiogram can be uploaded from the ultrasound scanner's 1206 hard disk to the computer implemented system 1200 for performing cardiac functional assessment in real time. The online and offline cardiac functional assessment modes provide a scanner-independent cardiac assessment system 1200.

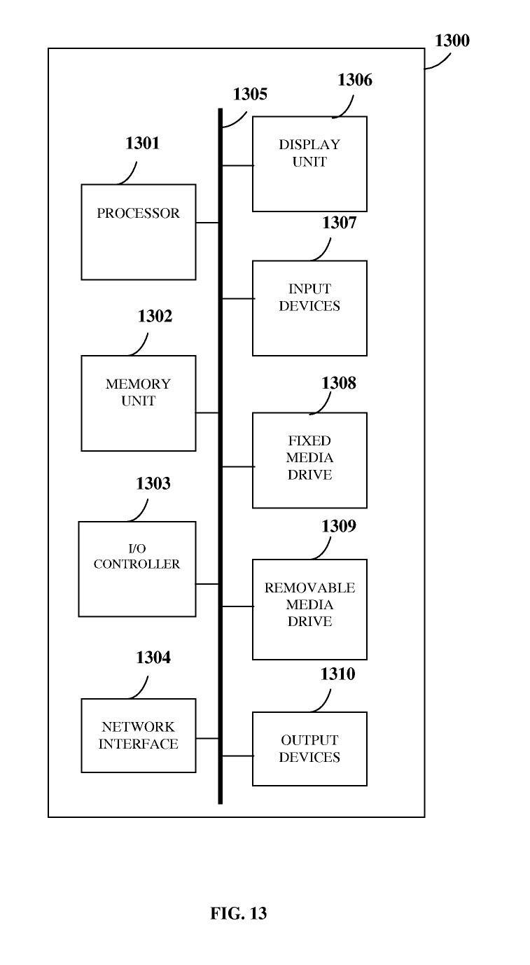

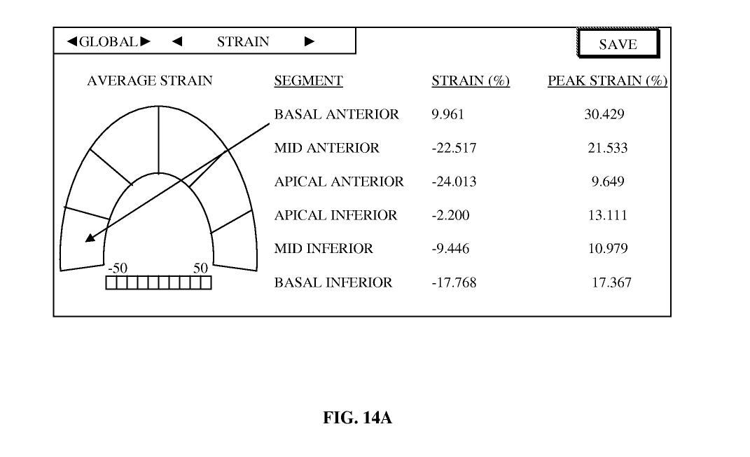

FIG. 13 exemplarily illustrates the architecture of a computer system 1300 used for automatic cardiac functional assessment. For purposes of illustration, the detailed description discloses the GUI 1202, the image processing unit 1203 and the quantitative assessment module 1204 installed on the computer system 1300 of the computing device 1201, however the scope of the computer implemented method and system 1200 disclosed herein is not limited to the GUI 1202, the image processing unit 1203, and the quantitative assessment module 1204 being installed on the computer system 1300 but may be extended to include the GUI 1202, the image processing unit 1203, and the quantitative assessment module 1204 being installed on the ultrasound scanner 1206, for example, an echocardiographic device.

The ultrasound scanner 1206, the echocardiogram database 1205, and the computing device 1201 communicate with each other via an interface or a short range/long range network. The network is, for example, a local area network (LAN). The computer system 1300 comprises, for example, a processor 1301, a memory unit 1302 for storing programs and data, an input/output (I/O) controller 1303, a network interface 1304, a network bus 1305, a display unit 1306, input devices 1307, a fixed media drive 1308, a removable media drive 1309, an output device 1310, for example, a printer, etc.

The processor 1301 is an electronic circuit that can execute computer programs. The memory unit 1302 is used for storing programs, applications, and data. For example, the image processing unit 1203 and the quantitative assessment module 1204 are stored on the memory unit 1302 of the computer system 1300. The memory unit 1302 is, for example, a random access memory (RAM) or another type of dynamic storage device that stores information and instructions for execution by the processor 1301. The memory unit 1302 also stores temporary variables and other intermediate information used during execution of the instructions by the processor 1301. The computer system 1300 further comprises a read only memory (ROM) or another type of static storage device that stores static information and instructions for the processor 1301. The network interface 1304 enables connection of the computer system 1300 to the network. The I/O controller 1303 controls the input and output actions performed by the user. The network bus 1305 permits communication between the modules, for example, 1202, 1203, 1203a , 1203b, 1203c, 1203d, 1203e, 1203f, 1203g, 1203h, 1203i, 1203_{j,} and 1204 of the computer implemented system 1200 disclosed herein.

The display unit 1306 displays, via the GUI 1202, the results computed by the image processing unit 1203 and the quantitative assessment module 1204 to the user. The input devices 1307 are used for inputting data into the computer system 1300. The input devices 1307 are, for example, a keyboard such as an alphanumeric keyboard, a joystick, a mouse, a touch pad, a light pen, etc. The computer system 1300 further comprises a fixed media drive 1308 and a removable media drive 1309 for receiving removable media.

Computer applications and programs are used for operating the computer system 1300. The programs are loaded onto the fixed media drive 1308 and into the memory unit 1302 of the computer system 1300 via the removable media drive 1309. In an embodiment, the computer applications and programs may be loaded directly through the network 804. Computer applications and programs are executed by double clicking a related icon displayed on the display unit 1306 using one of the input devices 1307. The user interacts with the computer system 1300 using the GUI 1202 of the display unit 1306.

The computer system 1300 of the computing device 1201 employs operating systems for performing multiple tasks. An operating system is responsible for the management and coordination of activities and the sharing of the resources of the computer system 1300. The operating system further manages security of the computer system 1300, peripheral devices connected to the computer system 1300, and network connections. The operating system employed on the computer system 1300 recognizes, for example, inputs provided by the user using one of the input devices 1307, the output display, files and directories stored locally on the fixed media drive 1308, etc. The operating system on the computer system 1300 of the computing device 1201 executes different programs initiated by the user using the processor 1301. Instructions for executing the GUI 1202, the image processing unit 1203, and the quantitative assessment module 1204 are retrieved by the processor 1301 from the program memory in the form of signals. Location of the instructions in the program memory is determined by a program counter (PC). The program counter stores a number that identifies the current position in the program of the GUI 1202, the image processing unit 1203, and the quantitative assessment module 1204.

The instructions fetched by the processor 1301 from the program memory after being processed are decoded. After processing and decoding, the processor 1301 executes the instructions. For example, the segmentation engine 1203a defines instructions for performing automatic segmentation of each of the ultrasonic cardiac images from an echocardiogram for delineating the endocardium boundary and the epicardium boundary using a segmentation algorithm. The segmentation engine 1203a defines instructions for identifying acoustic markers on the endocardium boundary of the ultrasonic cardiac images. The intensity profile generator 1203b defines instructions for generating intensity profile vectors on the ultrasonic cardiac images. The localization factor estimator 1203c defines instructions for estimating a localization factor. The initial contour generator 1203d defines instructions for generating an initial contour. The cardiac cycle calculator 1203e defines instructions for calculating the instantaneous heart beat rate and the average heart beat rate by determining frequency of the cardiac cycles. The tracking engine 1203f defines instructions for tracking the identified acoustic markers across the ultrasonic cardiac images over multiple cardiac cycles using the adaptive speckle tracking algorithm. The acoustic marker and search area adapter 1203g defines instructions for dynamically adapting the dimensions of the acoustic markers and the acoustic marker search blocks for tracking of the acoustic markers. The phase synthesizer 1203h defines instructions for constructing a synthetic phase component for robust tracking of the acoustic markers. The drift compensator 1203i defines instructions for shifting the location of the acoustic markers on the ultrasonic cardiac images at each subsequent periodic stage towards one or more reference acoustic markers located during the first periodic stage. The tilt estimator and corrector 1203j defines instructions for estimating and correcting a tilt in each of the ultrasonic cardiac images. The quantitative assessment module 1204 defines instructions for calculating cardiac parameters using the tracked acoustic markers on the ultrasonic cardiac images. The defined instructions are stored in the program memory or received from a remote server.

The processor 1301 retrieves the instructions defined by the GUI 1202, the segmentation engine 1203a, the intensity profile generator 1203b, the localization factor estimator 1203c, the initial contour generator 1203d, the cardiac cycle calculator 1203e, the tracking engine 1203f, the acoustic marker and search area adapter 1203g, the phase synthesizer 1203h, the drift compensator 1203i, the tilt estimator and corrector 1203j, and the quantitative assessment module 1204, and executes the instructions.

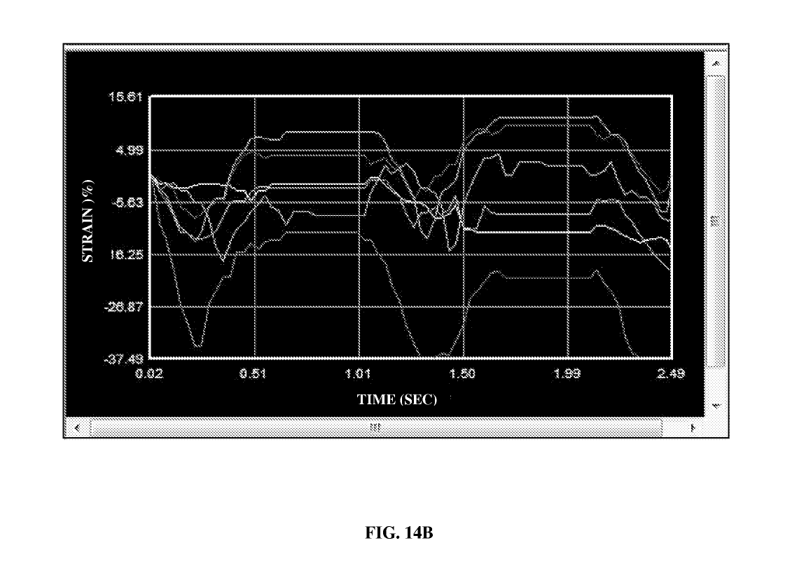

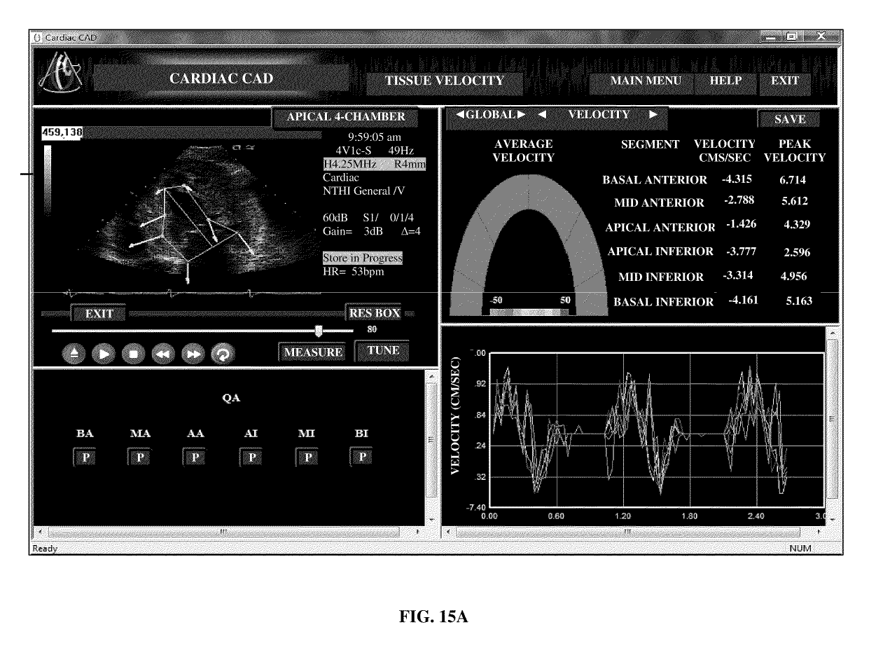

FIG. 14A exemplarily illustrates a graphical user interface 1202 for displaying the calculated cardiac parameters in a parametric format. The parametric format is a graphical and numeric representation of the left ventricle, where the ventricle is divided into six segments. Each segment is represented by two points. As such, there are a total of seven points or acoustic markers as illustrated in FIG. 4C. For each of the six segments, specific cardiac parameters are measured and displayed in color coded and numeric formats. The color coded format is superimposed on a graphical icon of the ventricle, while the numeric format is shown in a tabular format. The cardiac parameters comprise, for example, tissue displacement, velocity, strain, strain rate, etc. FIG. 14A exemplarily illustrates a parametric image of the tissue strain that is measured for all the six segments of the left ventricle. The parametric format is displayed in accordance to the model specified by the American Society of Echocardiography (ASE). This model is used by cardiologists for wall motion scoring, where each segment of the tissue wall is given a numeric score. For example, the percentage value of strain measured on the basal anterior segment at peak systole is approximately 9.961%. This is displayed in the tabular format of FIG. 14A and in the corresponding color-coded format, for example, in a specific color, depicted here by an arrow, on the graphical icon of the left ventricle. The parametric image in FIG. 14A represents the long axis view, for example, the Apical 4 Chamber (A4C) view of the left ventricle. Though the computer implemented method and system 1200 disclosed herein describes cardiac parameter measurement with respect to the long-axis view, the computer implemented method and system 1200 disclosed herein can also quantify parameters for the short-axis ventricular views, for example, short axis (SAX) view. FIG. 14B exemplarily illustrates a graphical user interface 1202 for displaying cardiac parameters or the tissue strain segmental parameters in a graphical format

FIGS. 15A-15B exemplarily illustrate screenshots of the graphical user interface 1202 for displaying cardiac parameters, for example, tissue velocity and ventricular ejection fraction. The user can configure the GUI 1202 to display cardiac parameters in a parametric format, a graphical format, or a combination of these. The GUI screen real estate can also feature moving image echocardiograms, with playback controls, showing the positions and the vector components of the acoustic markers.

A few applications of the computer implemented method and system 1200 disclosed herein include cardiac functional analysis for systematic assessment of heart failures and detection of other cardiac pathological conditions by cardiologists or echocardiographers. The cardiac parameters quantified by the computer implemented system 1200 are used by cardiologists along with their manual diagnostic procedures to detect and diagnose heart diseases. The cardiac parameters may also be used by cardiologists during progression therapies of existing cardiac patients. In an embodiment, the computer implemented system 1200 disclosed herein referred to as the cardiac functional assessment system 1200 categorizes each cardiac parameter into a normal range and an abnormal range based on the value of the parameter, for an easier interpretation by a cardiologist. FIGS. 16A-16C exemplarily illustrate screenshots of the left ventricle with varying shapes captured using different ultrasound scanners 1206 and segmented using the segmentation algorithm disclosed herein.

It will be readily apparent that the various methods and algorithms described herein may be implemented in a computer readable medium appropriately programmed for general purpose computers and computing devices. Typically a processor, for example, one or more microprocessors will receive instructions from a memory or like device, and execute those instructions, thereby performing one or more processes defined by those instructions. Further, programs that implement such methods and algorithms may be stored and transmitted using a variety of media, for example, computer readable media in a number of manners. In an embodiment, hard-wired circuitry or custom hardware may be used in place of, or in combination with, software instructions for implementation of the processes of various embodiments. Thus, embodiments are not limited to any specific combination of hardware and software. A “processor” means any one or more microprocessors, central processing unit (CPU) devices, computing devices, microcontrollers, digital signal processors or like devices. The term “computer readable medium” refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include dynamic random access memory (DRAM), which typically constitutes the main memory. Transmission media include coaxial cables, copper wire and fiber optics, including the wires that comprise a system bus coupled to the processor. Common forms of computer readable media include, for example, a floppy disk, a flexible disk, hard disk, magnetic tape, any other magnetic medium, a compact disc-read only memory (CD-ROM), digital versatile disc (DVD), any other optical medium, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, a carrier wave as described hereinafter, or any other medium from which a computer can read. In general, the computer readable programs may be implemented in any programming language. Some examples of languages that can be used include C, C++, C#, Perl, Python, or JAVA. The software programs may be stored on or in one or more mediums as an object code. A computer program product comprising computer executable instructions embodied in a computer readable medium comprises computer parsable codes for the implementation of the processes of various embodiments.

Where databases are described such as the echocardiogram database 1205, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired medium such as Ethernet based Local Area Network (LAN) or via any appropriate communications means or combination of communications means. Each of the devices may comprise computers, such as those based on the Intel® processors, AMD® processors, UltraSPARC® processors, Sun® processors, IBM® processors, etc. that are adapted to communicate with the computer. Any number and type of machines may be in communication with the computer.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

We claim:

1. A computer implemented method for performing automatic cardiac functional assessment using a series of ultrasonic cardiac images, comprising:
performing automatic segmentation of each of said ultrasonic cardiac images for delineating an endocardium boundary using a segmentation algorithm;
identifying a plurality of acoustic markers on said endocardium boundary on at least a first of said ultrasonic cardiac images;
tracking said identified acoustic markers across said ultrasonic cardiac images over a plurality of cardiac cycles using a tracking algorithm; and
calculating cardiac parameters using said tracked acoustic markers on said ultrasonic cardiac images.

2. The computer implemented method of claim 1, wherein said segmentation algorithm is a region based active contour algorithm, wherein said segmentation algorithm is configured to automatically delineate said endocardium boundary using localized image statistics.

3. The computer implemented method of claim 1, further comprising calculating a plurality of cross sectional intensity profiles on said ultrasonic cardiac images for estimating a localization factor and an initial contour, wherein said segmentation algorithm utilizes said localization factor and said initial contour for delineating said endocardium boundary.

4. The computer implemented method of claim 3, further comprising identifying said acoustic markers using said cross-sectional intensity profiles of a left ventricle on a first of said ultrasonic cardiac images.

5. The computer implemented method of claim 1, further comprising:
identifying an apex of a left ventricle by determining one or more acoustic markers with least displacement across said ultrasonic cardiac images;
identifying basal points of said left ventricle by determining one or more acoustic markers with largest displacement across said ultrasonic cardiac images and by using a predefined geometric relationship with said apex of said left ventricle; and
determining a long-axis and a short-axis of said left ventricle, wherein said long-axis is determined by joining said apex of said left ventricle and a mid point of a line segment that joins said basal points of said left ventricle, and wherein said short-axis is determined by a predetermined geometric interpolation between said apex of said left ventricle and said basal points of said left ventricle.

6. The computer implemented method of claim 1, further comprising delineating an epicardium boundary on said ultrasonic cardiac images comprising:
projecting said acoustic markers of said endocardium boundary in an outward direction perpendicular to a tangent line at each of said acoustic markers;
measuring intensity level along each of said projected acoustic markers to determine epicardium boundary points, wherein said epicardium boundary points define a range of intensity gradients; and
joining said determined epicardium boundary points to delineate said epicardium boundary.

7. The computer implemented method of claim 1, further comprising determining one or more periodic stages of each of said cardiac cycles using said segmented ultrasonic cardiac images, wherein said determination of said one or more periodic stages of each of said cardiac cycles comprises:
calculating an area defined within said endocardium boundary in each of said ultrasonic cardiac images;
determining one or more end-systole image frames among said ultrasonic cardiac images, wherein each of said one or more end-systole image frames defines a minimum area within said endocardium boundary; and
determining one or more end-diastole image frames among said ultrasonic cardiac images, wherein each of said one or more end-diastole image frames defines a maximum area within said endocardium boundary.

8. The computer implemented method of claim 7, further comprising calculating one or more of an instantaneous heart beat rate and an average heart beat rate by determining frequency of said cardiac cycles based on recurrence of one or more of said end-systole image frame pairs and said end-diastole image frame pairs.

9. The computer implemented method of claim 1, wherein said tracking algorithm is based on a speckle tracking algorithm, and wherein said tracking of said acoustic markers across said ultrasonic cardiac images using said tracking algorithm comprises:
tracking said acoustic markers by correlating said acoustic markers in a current ultrasonic cardiac image with their respective acoustic marker search blocks in a subsequent ultrasonic cardiac image, wherein said acoustic marker search blocks are employed for searching said acoustic markers on each of said ultrasonic cardiac images;
dynamically adapting dimensions of said acoustic markers based on parameters of image statistics; and
dynamically adapting dimensions of said acoustic marker search blocks based on frame rate of said ultrasonic cardiac images.

10. The computer implemented method of claim 1, further comprising constructing a synthetic phase component for tracking said acoustic markers, comprising:
calculating a resultant displacement of each of a set of adjacent acoustic markers in terms of individual phase components; and
determining a synthetic phase component for said set of adjacent acoustic markers based on an orientation of a majority of said individual phase components.

11. The computer implemented method of claim 1, further comprising compensating movement artifacts in said ultrasonic cardiac images by shifting location of said acoustic markers on each of subsequent end-systole image frames determined from among said ultrasonic cardiac images towards one or more reference acoustic markers located on a first of said end-systole image frames determined from among said ultrasonic cardiac images.

12. The computer implemented method of claim 1, further comprising compensating movement artifacts in said ultrasonic cardiac images by shifting location of said acoustic markers on each of subsequent end-diastole image frames determined from among said ultrasonic cardiac images towards one or more reference acoustic markers located on a first of said end-diastole image frames determined from among said ultrasonic cardiac images.

13. The computer implemented method of claim 1, further comprising estimating and correcting a tilt in each of said ultrasonic cardiac images, comprising:
dividing said ultrasonic cardiac images into at least four quadrants with reference to a vertical axis and a horizontal axis of a cardiac ultrasound;
calculating a tilt angle between a long-axis of a ventricular axis of a left ventricle and said vertical axis of said cardiac ultrasound from said delineated endocardium boundary; and
correcting said tilt angle by transforming coordinates of said ventricular axis of said left ventricle to align with coordinates of said cardiac ultrasound axis.

14. The computer implemented method of claim 1, wherein said cardiac parameters calculated using said tracked acoustic markers comprise tissue displacement and one or more derived cardiac parameters, wherein said one or more derived cardiac parameters comprise tissue velocity, tissue strain, tissue strain rate, ventricular volume, and ventricular ejection fraction.

15. The computer implemented method of claim 1, further comprising displaying said calculated cardiac parameters in one or more of a parametric format and a graphical format on a graphical user interface.

16. A computer implemented system for performing automatic cardiac functional assessment using a series of ultrasonic cardiac images, comprising:
a graphical user interface provided on a computing device that enables uploading of an echocardiogram from an echocardiogram database to said computing device and displays calculated cardiac parameters in one or more of a parametric format and a graphical format;
an image processing unit provided on said computing device, said image processing unit comprising:
a segmentation engine that performs automatic segmentation of each of said ultrasonic cardiac images from said echocardiogram for delineating an endocardium boundary using a segmentation algorithm;
said segmentation engine that identifies a plurality of acoustic markers on said endocardium boundary on at least a first of said ultrasonic cardiac images; and
a tracking engine that tracks said identified acoustic markers across said ultrasonic cardiac images over a plurality of cardiac cycles using a tracking algorithm; and
a quantitative assessment module provided on said computing device for calculating cardiac parameters using said tracked acoustic markers on said ultrasonic cardiac images.

17. The computer implemented system of claim 16, wherein said segmentation engine uses said segmentation algorithm based on a region based active contour algorithm configured to automatically delineate said endocardium boundary using localized image statistics, and to delineate an epicardium boundary on said ultrasonic cardiac images.

18. The computer implemented system of claim 16, wherein said segmentation engine comprises:
an intensity profile generator for generating a plurality of intensity profile vectors on one or more of said ultrasonic cardiac images;
a localization factor estimator for estimating a localization factor, said localization factor required to perform said segmentation;
an initial contour generator for generating an initial contour required to perform said segmentation; and
a cardiac cycle calculator for calculating one or more of an instantaneous heart beat rate and an average heart beat rate by determining frequency of said cardiac cycles based on recurrence of one or more end-systole image frame pairs and end-diastole image frame pairs.

19. The computer implemented system of claim 16, wherein said segmentation engine identifies said acoustic markers using a plurality of cross-sectional intensity profiles of a left ventricle on a first of said ultrasonic cardiac images.

20. The computer implemented system of claim 16, wherein said tracking engine for speckle tracking comprises an acoustic marker and search area adapter that dynamically adapts dimensions of said acoustic markers and acoustic marker search blocks for tracking of said acoustic markers.

21. The computer implemented system of claim 16, wherein said tracking engine for speckle tracking comprises a phase synthesizer that constructs a synthetic phase component for tracking of said acoustic markers, wherein said phase synthesizer performs:
calculating a resultant displacement of each of a set of adjacent acoustic markers in terms of individual phase components; and
constructing said synthetic phase component for said set of adjacent acoustic markers based on an orientation of a majority of said individual phase components.

22. The computer implemented system of claim 16, wherein said tracking engine comprises a drift compensator for compensating for movement artifacts in said ultrasonic cardiac images by shifting location of said acoustic markers on each of subsequent end-systole image frames determined from among said ultrasonic cardiac images towards one or more reference acoustic markers located on first of said end-systole image frames determined from among said ultrasonic cardiac images.

23. The computer implemented system of claim 22, wherein said drift compensator compensates for movement artifacts in said ultrasonic cardiac images by shifting location of said acoustic markers on each of subsequent end-diastole image frames determined from among said ultrasonic cardiac images towards one or more reference acoustic markers located on a first of said end-diastole image frames determined from among said ultrasonic cardiac images.

24. The computer implemented system of claim 16, wherein said tracking engine comprises a tilt estimator and corrector for estimating and correcting a tilt in each of said ultrasonic cardiac images for calculating longitudinal and radial components of said calculated cardiac parameters.

25. A computer program product comprising computer executable instructions embodied in a computer readable storage medium, wherein said computer program product comprises:
a first computer parsable program code for reading an echocardiogram and rendering quantified cardiac parameters;
a second computer parsable program code for performing automatic segmentation of each of a series of ultrasonic cardiac images from said echocardiogram for delineating an endocardium boundary using a segmentation algorithm;
a third computer parsable program code for tracking a plurality of acoustic markers across said ultrasonic cardiac images over a plurality of cardiac cycles using a tracking algorithm; and
a fourth computer parsable program code for calculating cardiac parameters using said tracked acoustic markers on said ultrasonic cardiac images and rendering said calculated cardiac parameters in one or more of a parametric format and a graphical format on a graphical user interface.
